(19) United States
(12) Patent Application Publication
(10) Pub. No.: US 2004/0164943 A1
(43) Pub. Date: Aug. 26, 2004

(54) Liquid crystal display device and driving method thereof

(76) Inventors: Yoshinori Ogawa, Nara (JP); Shigeki Tanaka, Kyoto (JP)

Correspondence Address: HARNESS, DICKEY & PIERCE, P.L.C., P.O. BOX 8910, RESTON, VA, 20195, US

(21) Appl. No.: 10/727,645

(22) Filed: Dec. 5, 2003

(30) Foreign Application Priority Data
Dec. 10, 2002 (JP) 2002-358429

(51) Int. Cl. G09G 3/36

(52) U.S. Cl. 345/92

(57) ABSTRACT

The liquid crystal display device includes: a plurality of scanning lines; a plurality of signal lines provided so as to cross the scanning signals; pixel capacitors, having pixel electrodes and counter electrodes (common electrodes), and corresponding to a liquid crystal layer, which are respectively formed on pixels corresponding to intersections of the scanning lines and the signal lines. The liquid crystal layer has liquid crystal molecules, aligned in random directions throughout a liquid crystal panel, each of which has a substantially fixed twist angle in a direction perpendicular to substrates for sandwiching the liquid crystal layer. In the liquid crystal display device, there is provided a Vcom adjustment circuit which supplies common electrode voltages to the counter electrodes (common electrodes) and is capable of adjusting the common electrode voltages. As a result, it is possible to display an image which can be viewed at a wider visual angle.

This Nonprovisional application claims priority under 35 U.S.C. § 119(a) on Patent Application No. 2002/358429 filed in Japan on Dec. 10, 2002, the entire contents of which are hereby incorporated by reference.

### FIELD OF THE INVENTION

The present invention relates to a liquid crystal display device and a driving method thereof, and particularly to a structure for enlarging a visual angle.

### BACKGROUND OF THE INVENTION

The demand for a liquid crystal display (LCD) is increasing due to its characteristic such as a compact body and low power consumption. Further, the LCD is being developed as a product which realizes a larger screen, higher definition, and higher gradation in terms of a function.

However, there is such a technical problem that: in the LCD, a visual angle, particularly a visual angle in an up-and-down direction, is narrower than in CRT and the like. The problem is explained as follows.

For example, currently, in a normally-white transmissive TN (twist nematic) type LCD which is often used for OA (Office Automation), a voltage applied to liquid crystal is varied so as to control its luminance. That is, the liquid crystal is sandwiched by two polarizing plates which are disposed so that a polarization axis crosses the polarizing plates in an orthogonal manner, and a voltage applied to the liquid crystal is varied so as to vary a condition under which liquid crystal molecules are aligned, so that light that has been linearly polarized by the polarizing plate positioned on the incident side is elliptically polarized, thereby transmitting only light, positioned on the outgoing side, which is projected in a direction of the polarization axis. As a result, the luminance is controlled.

Further, in the LCD for OA, a rubbing process is performed with respect to an alignment film so that a portion on the side of a thin film transistor (TFT) and a portion on the side of a color filter (CF) are respectively rubbed in directions shown in FIG. 42(a), thereby aligning liquid crystal molecules in the foregoing directions.

When the voltage is not applied to the liquid crystal, the liquid crystal molecules are aligned in a twisted manner under such condition that the liquid crystal molecules lie down. When, the voltage is applied to the liquid crystal, the liquid crystal molecules are aligned in a vertical direction. Further, the liquid crystal molecule has a refraction which differs in a major axis direction and in a minor axis direction. Thus, when the liquid crystal molecule lies down, the refraction is anisotropic on a surface through which light passes, and when the liquid crystal molecule stands up, the refraction is isotopic on the surface through which light passes. Thus, rotation of the polarization differs depending on the voltage applied to the liquid crystal. The rotational amount of the polarization is defined by multiplying (a) refraction anisotropy of the liquid crystal molecule (reflection in a major axis direction-reflection in a minor axis direction) by a gap of liquid crystal cells (this condition is referred to as “retardation”).

When the liquid crystal molecules are aligned in a direction shown in FIG. 42(a), the liquid crystal molecules are aligned with them twisted as shown in FIG. 42(b), so that the anisotropy caused by the retardation occurs. In this case, as shown in FIG. 42(c), the liquid crystal molecules are comparatively symmetrically aligned in a right-and-left direction, so that a visual angle is comparatively wider. In contrast, as shown in FIG. 42(d), the liquid crystal molecules are so asymmetrically aligned in an up-and-down direction, so that the visual angle is comparatively narrower. That is, when viewed from the upper side, the liquid crystal molecules seem to lie down, and when viewed from a lower side, the liquid crystal molecules seem to stand up. As a result, a black state is so conspicuous when viewed from an upper angular position in viewing (θ<0°), and gradation reversal occurs as shown in FIG. 43 when viewed from a lower angular position in viewing (θ>0°). This problem is particularly seen in a full-color LCD in which halftone is frequently used.

In order to widen the visual angle in a conventional LCD, it is necessary to be careful in managing the step of forming a TFT and the step of manufacturing a liquid crystal panel, and it is necessary to perform complicate manufacturing step, so that this raises such problem that the yield drops and the manufacturing cost increases.

As a method for solving the foregoing problem, Japanese Unexamined Patent Publication No. 194655/1994 (Tokukaihei 6-194655)(Publication date: Jul. 15, 1994) discloses a manufacturing method of a liquid crystal display device in which a rubbing process and an alignment film are not required.

In the manufacturing method, by using a multi-domain liquid crystal constituted of microdomains which are minute and are respectively aligned in random directions throughout a cell, it is possible to cause whole the display screen to display an image which is uniformed and does not vary depending on the visual angle.

However, according to the foregoing arrangement, by using a multi-domain liquid crystal constituted of microdomains which are minute and are respectively aligned in random directions throughout a cell, it is possible to cause whole the display screen to display an image which is uniformed and does not vary depending on the visual angle, but it is difficult to completely guarantee the alignment which realizes such display condition in whole the multi-domain liquid crystal.

### SUMMARY OF THE INVENTION

The object of the present invention is to provide a liquid crystal display device and a driving method thereof by which it is possible to appropriately display an image which can be viewed at a wider visual angle.

In order to achieve the foregoing object, the liquid crystal display device according to the present invention includes: a plurality of scanning lines; a plurality of signal lines provided so as to cross the scanning signals; pixel capacitors, having pixel electrodes and common electrodes, and corresponding to a liquid crystal layer, which are respectively formed on pixels corresponding to intersections of the scanning lines and the signal lines, wherein the liquid crystal layer has liquid crystal molecules, aligned in random directions throughout a liquid crystal panel, each of which has a substantially fixed twist angle in a direction perpendicular to substrates for sandwiching the liquid crystal layer, said liquid crystal display device including a common electrode voltage supplying circuit for supplying common electrode voltages to the common electrodes so that the common electrode voltages are adjustable.

Further, the method of the present invention is to drive the liquid crystal display device which includes: a plurality of scanning lines; a plurality of signal lines provided so as to cross the scanning signals; pixel capacitors, having pixel electrodes and common electrodes, and corresponding to a liquid crystal layer, which are respectively formed on pixels corresponding to intersections of the scanning lines and the signal lines, wherein the liquid crystal layer has liquid crystal molecules, aligned in random directions throughout a liquid crystal panel, each of which has a substantially fixed twist angle in a direction perpendicular to substrates for sandwiching the liquid crystal layer, and the method includes the step of supplying common electrode voltages and adjusting the common electrode voltages.

According to the foregoing arrangement, by adjusting the common electrode voltages supplied to the common electrodes as required, it is possible to adjust luminance of pixels and to correct color variation so as to widen a visual angle at which an observer views a display image from an arbitrary position. Thus, it is possible to appropriately display an image which can be viewed at a wider visual angle.

Further, as described above, the luminance of the pixels is adjusted and the color variation is corrected by adjusting the common electrode voltages supplied to the common electrodes, so that it is not necessary to adopt a complicate step of manufacturing the TFT or to remake a driving circuit. Thus, it is possible to obtain a high-performance liquid crystal display device at lower cost. Further, it is possible to easily correct the color variation, caused by viewing from different angular positions in viewing, in accordance with a material for the liquid crystal and a characteristic of the liquid crystal display device, so that this arrangement is applicable to various kinds of liquid crystal display devices which are different from each other in terms of the characteristic.

The liquid crystal display device may be arranged so that: the common electrodes of the pixels are divided into a plurality of groups, and the common electrode voltage supplying circuit is capable of respectively adjusting the common electrode voltages so that the common electrode voltages are adjusted independently every groups.

Further, the method for driving the liquid crystal display device may be arranged so that: the common electrodes of the pixels are divided into a plurality of groups, and the common electrode voltages are respectively adjusted so as to be adjusted independently every groups.

According to the foregoing arrangement, for example in the liquid crystal display device having such a characteristic that the visual angle varies depending on a position at which the observer views an image in an up-and-down direction, the common electrodes are divided into a plurality of groups each of which corresponds to each of the pixels, and each of the common electrode voltages is adjusted for each of the groups, so that it is possible to appropriately adjust the visual angle, at the position where the observer views the image in an up-and-down direction for example.

The liquid crystal display device may be arranged so that: at least first pixel capacitors and second pixel capacitors are provided on each of the pixels as the pixel capacitors, and the common electrode voltage supplying circuit is capable of respectively independently adjusting a common electrode voltage supplied to common electrodes corresponding to the first pixel capacitors and common electrode voltages supplied to common electrodes corresponding to the second pixel capacitors.

Thus, it is possible to appropriately adjust the common electrode voltage in the multi-domain liquid crystal display device which includes, as the pixel capacitor, at least the first pixel capacitor and the second pixel capacitor that are provided in each pixel.

The liquid crystal display device may be arranged so that: the common electrodes corresponding to the second pixel capacitors are divided into a plurality of groups, and the common electrode voltage supplying circuit supplies the common electrode voltage of an equal value to each other to the common electrodes corresponding to the first pixel capacitors, and is capable of respectively adjusting the common electrode voltages supplied to the common electrodes corresponding to the second pixel capacitors independently every groups.

Thus, with a simple structure, it is possible to adjust the common electrode voltages supplied to the common electrodes of the multi-domain liquid crystal display device which includes, as the pixel capacitor, at least the first pixel capacitor and the second pixel capacitor that are provided in each pixel.

The liquid crystal display device may be arranged so that: the common electrodes corresponding to the first pixel capacitors are divided into a plurality of groups, and the common electrode corresponding to the second pixel capacitors are divided into a plurality of groups, and the common electrode voltage supplying circuit is capable of respectively adjusting the common electrode voltage supplied to the common electrodes corresponding to the first pixel capacitor independently every groups and is capable of respectively adjusting the common electrode voltages supplied to the common electrodes corresponding to the second pixel capacitors independently ever groups.

Thus, it is possible to delicately control the common electrode voltages supplied to the common electrodes of the multi-domain liquid crystal display device which includes, as the pixel capacitor, at least the first pixel capacitor and the second pixel capacitor that are provided in each pixel, that is, it is possible to delicately control a display condition of the pixels.

The liquid crystal display device may be arranged so that: the common electrodes are grouped for n lines of the scanning lines (n includes one), where n is a positive integer.

The liquid crystal display device may be arranged so that: the common electrode voltage supplying circuit supplies a common electrode voltage which functions as a reference common electrode voltage to a first group corresponding to a scanning line centered in a direction in which the scanning lines are disposed, and the common electrode voltage supplying circuit supplies a common electrode voltages which is higher than the reference common electrode voltage to a second group corresponding to a scanning line positioned on the one side in the direction in which the scanning lines are disposed, and the common electrode voltage supplying circuit supplies a common electrode voltage which is lower than the reference common electrode voltage to a third group corresponding to a scanning line positioned on the other side in the direction in which the scanning lines are disposed.

According to the foregoing arrangement, it is possible to perform appropriate adjustment required in widening the visual angle in a liquid crystal display device whose display characteristic differs in the first group corresponding to the scanning lines centered in the direction in which the scanning signals are disposed, the second group corresponding to the scanning lines positioned on one side in the direction in which the scanning signals are disposed, and the third group corresponding to the scanning lines positioned on the other side in the direction in which the scanning signals are disposed. In other words, it is possible to perform appropriate adjustment required in widening the visual angle in a liquid crystal display device whose display characteristic differs in three areas divided in a direction, in which the scanning lines are disposed, such as an up-and-down direction with respect to the image for example.

The liquid crystal display device may be arranged so as to include a signal line driving circuit for supplying a display signal voltage to each of the signal lines, wherein the common electrode voltage supplying circuit is provided in the signal line driving circuit.

The liquid crystal display device may be arranged so that: the common electrode voltage supplying circuit adjusts the common electrode voltages supplied to the groups so that luminance of the pixels gradually varies so as to be monotonously darker or so as to be monotonously brighter from one end side to a center of the scanning lines in a direction in which the scanning lines are disposed.

According to the foregoing arrangement, it is possible to perform appropriate adjustment required in widening the visual angle in a liquid crystal display device which has such characteristic that: luminance of the pixels gradually varies so as to be darker or brighter while moving from one side to a central in a direction, in which the scanning lines are disposed, such as an up-and-down direction with respect to the image for example.

The liquid crystal display device may be arranged so that: the common electrode voltage supplying circuit includes an input operation circuit which allows adjustment amounts of the common electrode voltages to be inputted.

According to the foregoing arrangement, it is possible more easily adjust the common electrode voltages by providing a pinch or the like (input operation circuit) on the liquid crystal display device.

The liquid crystal display device may be arranged so as to include: a scanning line driving circuit for driving the scanning lines; and a reference voltage generating circuit for generating reference voltages, having plural levels different from each other, which are supplied to the scanning line driving circuit so as to make gradation display in accordance with a display signal, said reference voltage generating circuit being capable of adjusting the reference voltages.

Further, the method for driving the liquid crystal display device may be arranged so as to include the step of generating reference voltages, having plural levels, which cause gradation display to be made in accordance with a display signal, and adjusting the reference voltages.

According to the foregoing arrangement, reference voltages, having plural levels, which cause gradation display to be made in accordance with a display signal is generated, and the reference voltages are adjusted, so that it is possible to simplify a circuit for gradation display by making the circuit rationalized and shared unlike an arrangement in which a large number of resistance elements and switches generate a large number of gradation voltages.

The liquid crystal display device may be arranged so that: the reference voltage generating circuit adjusts the reference voltages so that a predetermined gamma characteristic is obtained in an arbitrary line of lines each of which is constituted of the pixels provided in a direction in which the scanning lines are disposed.

The method for driving the liquid crystal display device may be arranged so that: the reference voltages are adjusted so that a predetermined gamma characteristic is obtained in an arbitrary line of lines each of which is constituted of the pixels provided in a direction in which the scanning lines are disposed.

According to the foregoing arrangement, it is possible to obtain not only the luminance of the pixels but also a predetermined gamma characteristic in a line constituted of the pixels disposed in a direction in which the scanning lines are disposed, so that it is possible to realize more preferable display.

The liquid crystal display device may be arranged so as to include a correction information storage circuit for storing adjustment amounts of the reference voltages, wherein the reference voltage generating circuit adjusts the reference voltages in accordance with the adjustment amounts stored in the correction information storage circuit.

According to the foregoing arrangement, it is possible to easily adjust the gamma characteristic by rewriting the adjustment amount stored in the correction information storage circuit.

The liquid crystal display device may be arranged so that: the reference voltage generating circuit adjusts the reference voltages so that a gamma characteristic is obtained in a line, constituted of the pixels, which is positioned on the one side in a direction in which the scanning lines are disposed and another gamma characteristic is obtained in a line, constituted of the pixels, which is positioned on the other side in the direction in which the scanning lines are disposed, said gamma characteristics being different from each other

According to the foregoing arrangement, it is possible to adjust the reference voltages so that a gamma characteristic is obtained in a line, constituted of the pixels, which is positioned on one side in a direction in which the scanning lines are disposed and another gamma characteristic is obtained in a line, constituted of the pixels, which is positioned on other side in the direction in which the scanning lines are disposed, said gamma characteristics being different from each other, so that it is possible to more delicately adjust a display condition.

The liquid crystal display device may be arranged so that: the reference voltage generating circuit adjusts the reference voltages so as to obtain gamma characteristics different from each other in a first line constituted of the pixels provided on the one side in a direction in which the scanning lines are disposed, a second line constituted of the pixels provided on the other side in the direction in which the scanning lines are disposed, and a third line constituted of the pixels provided between the first line and the second line so that the gamma characteristic obtained in the third line is intermediate between the gamma characteristic obtained in the first line and the gamma characteristic obtained in the second line.

Thus, it is possible to appropriately adjust the gamma characteristic in a direction, in which the scanning lines are disposed, such as an up-and-down direction with respect to the display image, so that it is possible to realize more preferable display.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit diagram showing a structure of a TFT-type liquid crystal panel in one embodiment of the present invention.

FIG. 2 is a block diagram showing a structure of a liquid crystal display device provided with the liquid crystal panel shown in FIG. 1.

FIG. 3 is a circuit diagram showing the liquid crystal panel of FIG. 1 except for a driver.

FIG. 4 is a waveform schematic showing an example of a general liquid crystal driving waveform.

FIG. 5 is a waveform schematic showing another example of the liquid crystal driving waveform shown in FIG. 4, and shows a case where a voltage applied to a liquid crystal layer is lower than a voltage in a case of FIG. 4.

FIG. 6 is a block diagram showing a structure of a source driver section provided with a source driver of the liquid crystal display device shown in FIG. 2.

FIG. 7 is a block diagram schematically showing a structure of a Vcom adjustment circuit shown in FIG. 1.

FIG. 8(a) shows how a constant current source in the Vcom adjustment circuit of FIG. 7 operates, and illustrates a case of obtaining an output voltage higher than a reference voltage, and FIG. 8(b) illustrates a case of obtaining an output voltage lower than the reference voltage.

FIG. 9 is a circuit diagram showing a structure of the constant current source shown in FIG. 7.

FIG. 10 is a waveform schematic showing an example of a liquid crystal driving waveform in the liquid crystal display device shown in FIG. 2.

FIG. 11 is a waveform schematic showing another example of the liquid crystal driving waveform shown in FIG. 10, and illustrates a case where the voltage applied to the liquid crystal layer is lower than a voltage in a case of FIG. 10.

FIG. 12 is a schematic showing a condition under which a counter electrode voltage is applied from the Vcom adjustment circuit of FIG. 1 to the liquid crystal panel.

FIG. 13 is a schematic showing a condition under which the counter electrode voltage is applied from the Vcom adjustment circuit of FIG. 1 to the liquid crystal panel in two sequential frames.

FIG. 14 is a circuit diagram showing a structure of a liquid crystal display element corresponding to a single pixel of a multi-domain liquid crystal panel.

FIG. 15 is a circuit diagram showing a condition under which the structure of the liquid crystal panel of FIG. 1 is applied to the multi-domain liquid crystal panel.

FIG. 16 is a circuit diagram showing another example of the structure of the liquid crystal panel that is shown in FIG. 15.

FIG. 17 is a block diagram showing a structure of a TFT-type liquid crystal display device in another embodiment of the present invention.

FIG. 18 is a block diagram schematically showing a structure of a reference voltage generating circuit shown in FIG. 17.

FIG. 19 is a block diagram schematically showing a structure of a conventional reference voltage generating circuit compared with the reference voltage generating circuit of FIG. 18.

FIG. 20 is a block diagram showing a structure of a γ correction adjustment circuit shown in FIG. 18.

FIG. 21(a) shows how a constant current source of the γ correction adjustment circuit of FIG. 20 operates, and illustrates a case of obtaining an output voltage higher than a reference voltage, and FIG. 21(b) illustrates a case of obtaining an output voltage lower than the reference voltage.

FIG. 22 is a circuit diagram showing a structure of the constant current source shown in FIG. 20.

FIG. 23 is a graph showing a relationship (γ correction characteristic) between gradation display data (digital input) and a liquid crystal driving output voltage (analog voltage) in a reference voltage generating circuit shown in FIG. 21(a) and FIG. 21(b).

FIG. 24 is a schematic showing a condition under which γ correction characteristics γ1 and γ2 that are shown in FIG. 23 are applied to each pixel of the liquid crystal panel.

FIG. 25 is a schematic showing a condition under which the γ correction characteristics γ1 and γ2 that are shown in FIG. 23 are applied to each pixel of the liquid crystal panel in two sequential frames.

FIG. 26 is a schematic showing another example of the process shown in FIG. 24, and shows a condition under which γ correction characteristics γ1, γ2, and γ3 are applied to each pixel.

FIG. 27 is a schematic showing how a condition of the liquid crystal panel varies in two sequential frames when using the γ correction characteristics γ1, γ2, and γ3 that are shown in FIG. 26.

FIG. 28 is a block diagram schematically showing a structure of the Vcom adjustment circuit shown in FIG. 17.

FIG. 29 is a graph showing a relationship between a voltage applied to the liquid crystal cell and luminance (transmittance) of a single pixel when the liquid crystal panel is viewed from each angular position in viewing Φ.

FIG. 30(a) illustrates a condition under which an upper portion and a lower portion of the liquid crystal panel are different from each other in terms of a visual angle, and FIG. 30(b) illustrates a liquid crystal display device of the present invention which solves the condition of FIG. 30(a), and FIG. 30(c) is a block diagram schematically showing a structure of a source driver used to solve the condition of FIG. 30(a).

FIG. 31 is a circuit diagram showing a structure of a single pixel, having two sub-pixels, which is provided in the liquid crystal panel.

FIG. 32(a) is a graph showing a relationship between a signal voltage in the pixel shown in FIG. 31 and light intensity of the pixel, and FIG. 32(b) is a graph obtained by partially enlarging a range of the light intensity of the pixel that is shown in FIG. 32(a).

FIG. 33(a) shows a case where a visual angle distribution of the liquid crystal display device is adjusted into a predetermined condition, and illustrates a case of setting an image to be clearly observed when viewed from the upper side of the image, and FIG. 33(b) illustrates a case of setting the image to be clearly observed when viewed from the lower side of the image.

FIG. 34 illustrates an example of a visual angle distribution of the present invention that can be obtained by adjusting both the visual angle distributions shown in FIG. 33(a) and FIG. 33(b).

FIG. 35 illustrates a condition under which a visual angle characteristic varies depending on whether an image is viewed from the upper side or lower side in a conventional liquid crystal display device with a large screen.

FIG. 36 illustrates a structure of a conventional source driver for generating a voltage applied to the liquid crystal panel by using each of voltages divided by a resistance dividing circuit, and a condition under which the liquid crystal panel displays an image by means of the source driver.

FIG. 37 is a graph showing a γ characteristic fixed by the structure shown in FIG. 36.

FIG. 38(a) illustrates a structure of a source driver of an embodiment of the present invention which source driver generates a voltage applied to the liquid crystal panel, and a condition under which the crystal panel displays an image by means of the source driver, and FIG. 38(b) illustrates a condition under which a voltage subjected to γ correction by means of the source driver is applied to the liquid crystal panel.

FIG. 39 illustrates a condition under which a uniformly displaying technique based on division of the counter electrodes and a γ adjustment technique based on a non-volatile memory internally provided are adopted with respect to the liquid crystal display device of the embodiment of the present invention.

FIG. 40 illustrates a structure of a display memory provided in the liquid crystal display device of the embodiment of the present invention.

FIG. 41 is a timing chart showing how the display memory shown in FIG. 40 operates.

FIG. 42(a) illustrates a direction in which a liquid crystal molecule is aligned in a front side of the liquid crystal panel and a direction in which the liquid crystal molecule is aligned in a rear side of the liquid crystal panel, FIG. 42(b) illustrates a condition under which the liquid crystal molecule is aligned when viewed from an upper direction upon setting the alignment directions as shown in FIG. 42(a), and FIG. 42(c) illustrates a condition under which the liquid crystal molecule is aligned when viewed from a right-and-left direction upon setting the alignment directions as shown in FIG. 42(a), and FIG. 42(d) illustrates a condition under which the liquid crystal molecule is aligned when viewed from an up-and-down direction upon setting the alignment directions as shown in FIG. 42(a).

FIG. 43 is a graph showing a relationship between a voltage applied to the liquid crystal and luminance in the case where the liquid crystal panel is viewed from a front direction and from an-up-and-down direction upon setting the alignment directions as shown in FIG. 42(a).

### DESCRIPTION OF THE PREFERRED EMBODIMENTS

[Embodiment 1]

The following description will explain one embodiment of the present invention with reference to the drawings.

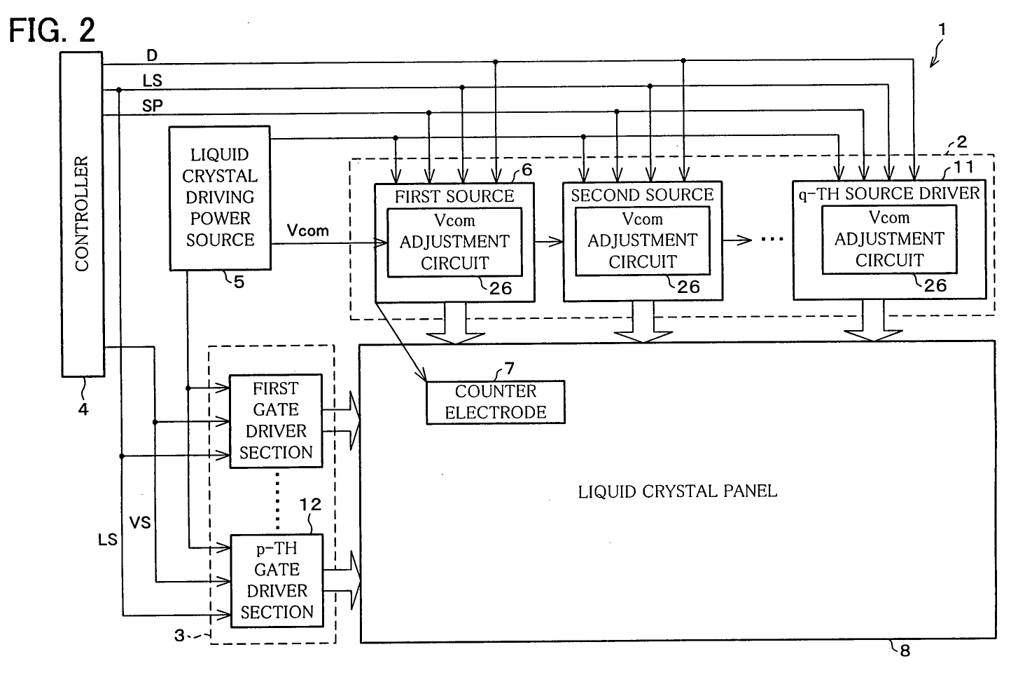

FIG. 2 is a block diagram showing a structure of a liquid crystal display device (TFT liquid crystal module) of the present embodiment.

The liquid crystal display device 1 is constituted of a liquid crystal display section for displaying an image and a liquid crystal driving section (liquid crystal driving circuit) for driving the liquid crystal display section in terms of a function. The liquid crystal display section includes a TFT-system liquid crystal panel 8. The liquid crystal panel 8 has a liquid crystal display element (not shown) and one or more counter electrodes 7 described later.

The liquid crystal driving circuit includes a source driver (signal line driving means) 2, a gate driver (scanning line driving means) 3, a controller 4, and a liquid crystal driving power source 5. The source driver 2 has a plurality of source driver sections 11 each of which is constituted of an IC (Integrated Circuit), that is, first to n-th source drivers. Likewise, the gate driver 3 includes a plurality of gate driver sections 12 each of which is constituted of an IC, that is, first to m-th gate drivers.

Each of the source driver 2 and the gate driver 3 is generally constituted, for example, of a TCP (Tape Carrier Package) in which the IC chip is provided on a film having wirings. The TCP is provided on an ITO (Indium Tin Oxide) terminal of the liquid crystal panel 8 so as to be connected to the liquid crystal panel 8. Alternatively, the IC chip is provided directly on the ITO terminal of the liquid crystal panel 8 via an ACF (Anisotropic Conductive Film) in accordance with thermal pressure so as to be connected to the liquid crystal panel 8.

The controller 4 inputs display data D and a control signal (start pulse SP or the like) to the source driver 2, and inputs a vertical synchronization signal VS to the gate driver 3. Further, the controller 4 inputs a horizontal synchronization signal LS to the source driver 2 and the gate driver 3.

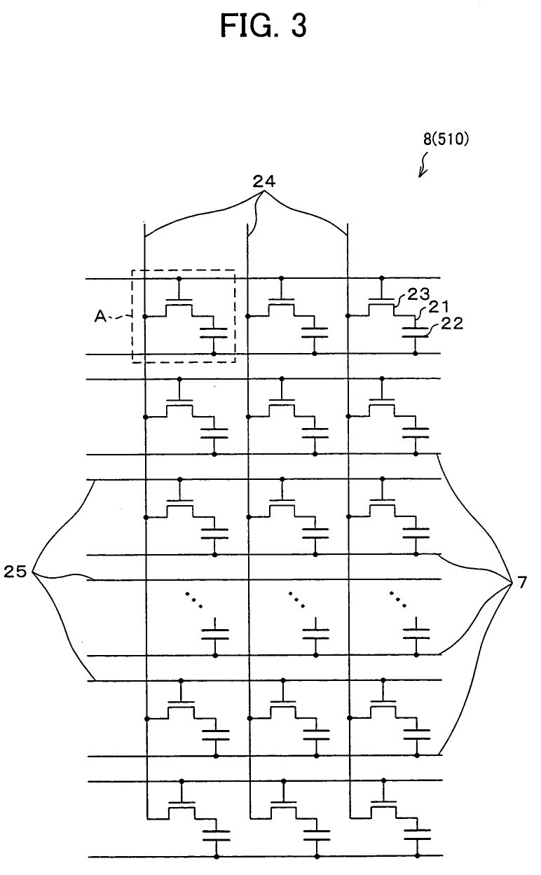

FIG. 3 shows a structure of the liquid crystal panel 8. The liquid crystal panel 8 includes a pixel electrode 21, a pixel capacitor 22, a TFT 23 for controlling whether or not to apply a voltage to a pixel electrode 21, a source line (signal line) 24, a gate line (scanning line) 25, and the counter electrode 7 (common electrode). Here, the pixel electrode 21, the pixel capacitor 22, and the TFT 23 constitute a liquid crystal display element A corresponding to a single pixel.

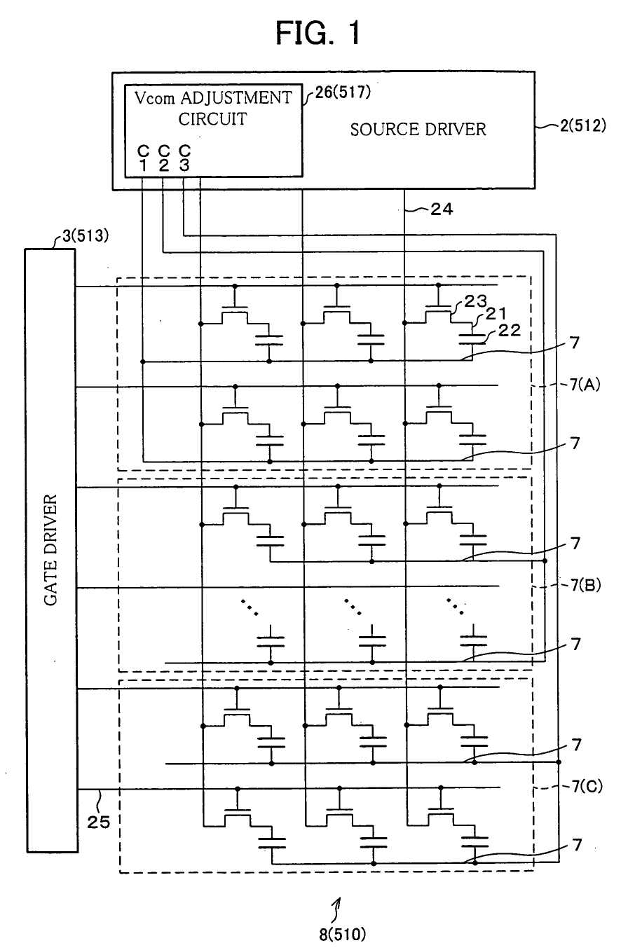

As shown in FIG. 1, the counter electrodes 7 are sequentially allocated to one or e gate lines 25 (e is a positive integer) as each group. Alternatively, the counter electrodes 7 are allocated to a plurality of gate lines 25 adjacent to each other as each group. A Vcom adjustment circuit (common electrode voltage supplying means) provided in the source driver 2 supplies counter electrode voltages C respectively to the counter electrodes 7 of each group.

For example, in a case where all the counter electrodes 7 of the liquid crystal panel 8 are divided into a first group 7(A), a second group 7(B), and a third group 7(C), the Vcom adjustment circuit 26 supplies counter electrode voltages C1, C2, and C3 to the counter electrodes 7 of these first to third groups.

As to the foregoing structure, a display operation of the liquid crystal display device 1 is described as follows.

Display data inputted from the outside is inputted to the source driver 2 via the controller 4 as the display data D which is a digital signal. The source driver 2 divides the inputted display data D in terms of time so as to latch the display data D to first to n-th source drivers. Thereafter, the source driver 2 performs DA conversion in synchronism with the horizontal synchronization signal LS inputted from the controller 4. Further, an analog voltage (hereinafter, referred to as gradation display voltage) for gradation display caused by performing the DA conversion with respect to the display data D divided in terms of time is outputted via the source line 24 to a corresponding liquid crystal display element of the liquid crystal panel 8.

The source driver 2 supplies the gradation display voltage, according to brightness of a target display pixel, to the source line 24. While, the gate driver 3 supplies a scanning signal, causing TFTs 23 to sequentially turn ON in a row direction, to the gate line 25. Further, the gradation display voltage of the source line 24 is applied via the TFT 23 turned ON to the counter electrode 7 connected to the drain of the TFT 23, and is stored in the pixel capacitor 22 positioned between the counter electrode 7 and the pixel electrode 21. In this manner, optical transmittance of the liquid crystal is varied according to the gradation display voltage so as to display an image. Further, in the present embodiment, the Vcom adjustment circuit 26 provided in the source driver supplies the counter electrode voltages C1, C2, and C3 respectively to three groups of the counter electrode 7: the first group 7(A), the second group 7(B), and the third group 7(C).

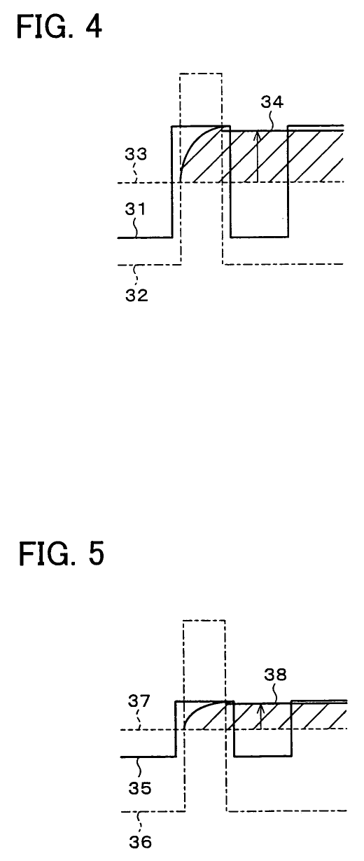

FIG. 4 and FIG. 5 show an example of a general liquid crystal driving waveform. In FIG. 4 and FIG. 5, 31 and 35 indicate a driving waveform of an output from the source driver 2, and 32 and 26 indicate a driving waveform of an output from the gate driver 3. Further, 33 and 37 indicate a potential of the counter electrode 7, and 34 and 38 indicate a voltage waveform of a voltage of the pixel electrode 21. Note that, a voltage applied to a liquid crystal layer is a potential difference between the pixel electrode 21 and the counter electrode 7, and is indicated by a shaded area in FIG. 4 and FIG. 5.

For example, in the case of FIG. 4., the TFT 23 is ON only at a period in which a level of the driving waveform 32 of the gate driver 4 is high, so that a voltage corresponding to a difference between the driving waveform 31 of the source driver 3 and the potential 33 of the counter electrode 7 is applied to the pixel electrode 21. Thereafter, a level of the driving waveform 32 of the gate driver 4 is low, so that the TFT 23 is OFF. In this case, the pixel capacitor 22 exists in the pixel, so that the aforementioned voltage is kept.

An operation indicated in FIG. 5 is substantially the same as in FIG. 4. However, FIG. 5 is different from FIG. 4 in terms of the voltage applied to the liquid crystal layer. In the case of FIG. 4, the applied voltage is higher than that of FIG. 5.

In the liquid crystal display device 1, the voltage applied to the liquid crystal layer is varied as the analog voltage in this manner, so that the optical transmittance of the liquid crystal is varied in an analog manner, thereby realizing multiple tone display.

Further, the liquid crystal display device 1 is to solve the following problem: liquid crystal is aligned asymmetrically particularly in an up-and-down direction, so that a visual angle is narrowed. In order to solve such problem, the liquid crystal display device 1 is arranged so that: as described above, the counter electrodes 7 are divided into a plurality of groups (7(A), 7(B), 7(C), . . . ), and different counter electrode voltages C1, C2, C3, are applied from the Vcom adjustment circuit 26 of the source driver 2 to the counter electrodes 7 of the groups respectively. Thus, it is possible to vary the luminance characteristic so as to obtain a most appropriate view at each angular position in viewing, so that it is possible to correct color variation caused by the difference in the angular position in viewing. Note that, in the present embodiment, “angular position in viewing” means an angle between a visual line (visual axis) and a normal line of the display image. Further, “most appropriate view” means a view which causes an image to seem uniformed in a direction of a visual line of an observer.

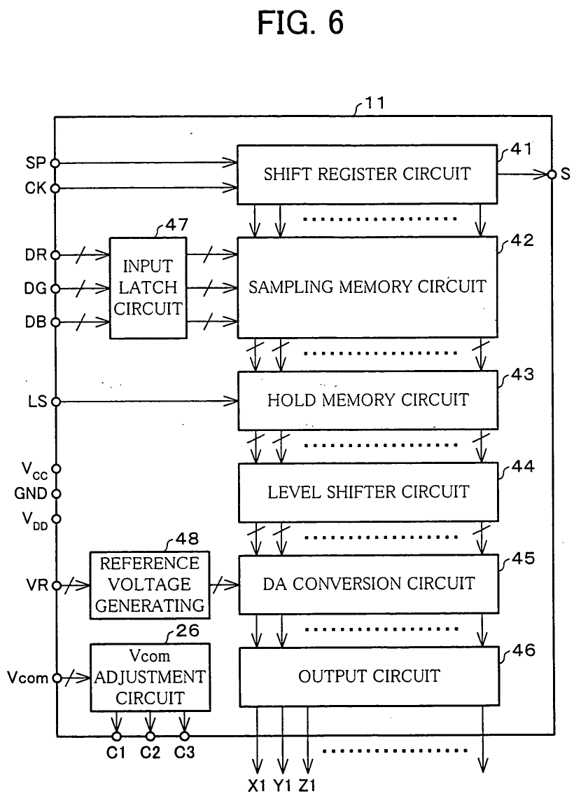

FIG. 6 is a block diagram showing an example of a structure of a source driver section (n-th source driver) 11 of the source driver shown in FIG. 2.

FIG. 6 shows a condition of the source driver section 11 in which the display data D (DR, DG, and DB) required in displaying an image are inputted in a serial manner, and the display data D are temporarily latched by an input latch circuit 47. Thereafter, in the sampling memory circuit 42, the display data D that have been transmitted in a time-divisional manner are sampled in accordance with an output signal at each stage of the shift register circuit 41. Then, the sampled display data D are outputted to a corresponding hold memory circuit 43 at the next stage. S is a cascade output.

The hold memory circuit 43 corresponds respectively to the first to n-th pixels, i.e., the first to n-th source lines 24 contained in the respective rows of the liquid crystal panel 8.

The display data D inputted to the hold memory circuit 43 are latched in accordance with the horizontal synchronization signal LS. Thus, until the next horizontal synchronization signal LS is inputted, the display data D outputted from the hold memory circuit 43 are fixed.

The level shifter circuit 44 performs level conversion, such as pressurization, with respect to the display data D outputted from the hold memory circuit 43 so as to correspond to a signal processing level of a DA conversion circuit 45 positioned at the next stage, and the display data D are inputted to the DA conversion circuit 45.

A reference voltage generating circuit 48 generates a reference voltage of each level in accordance with an original voltage VR. Specifically, when a potential that should be given to the pixel is inputted from the power source circuit (not shown), the potential is internally divided so as to generate 64 types of gradation display potentials in a case of 64-gradaion display for example, and the gradation display potentials are outputted to the DA conversion circuit 45. The DA conversion circuit 45 selects a single gradation display potential, corresponding to the display data D outputted from the level shifter circuit 44, out of 64 types of the gradation display potentials for each pixel, and outputs the single gradation display potential to an output circuit 46.

The output circuit 46 is a low impedance conversion section constituted of a differential amplifier and the like, and gives the gradation display potential selected by the DA conversion circuit 45 to the respective first to n-th source lines 24 of the liquid crystal panel 8. The gradation display potential is maintained in one period of the horizontal synchronization signal LS, i.e., one horizontal synchronization period, and a gradation display potential corresponding to new display data D is outputted at the next horizontal synchronization period.

While, the gate driver 3 includes a shift register circuit, a level shifter circuit, and an output circuit. In the gate driver 3, the horizontal synchronization signal LS and the vertical synchronization signal VS are inputted to the shift register circuit, and the horizontal synchronization signal LS is used as a clock so as to cause respective stages in the shift register circuit to sequentially output the vertical synchronization signals VS.

Outputs from the respective stages of the shift register circuit respectively correspond to first to m-th pixels, i.e., first to m-th gate lines 25 included in the respective rows of the liquid crystal panel 8. The outputs from the respective stages of the shift register circuit are subjected to level conversion performed by the level shifter circuit, so that the outputs are pressurized to a voltage which can control a gate of the TFT 23 of each pixel. Further, the outputs are subjected to low impedance conversion by means of the output circuit, and are outputted from the output circuit to respective first to m-th gate lines 25 of the liquid crystal panel 8. Each of the outputs from the gate driver 3 is a scanning signal, and ON/OFF of the gate of the TFT 23 in each pixel of the liquid crystal panel 8 is controlled in accordance with the scanning signal.

Operations of the source driver section 11 of the liquid crystal display device 1 are described as follows.

Each of the display data D (DR, DB, and DG) transmitted from a controller 4 is 6 bits, and is temporarily latched by an input latch circuit 47.

The shift register circuit 41 is a circuit for shifting, that is, forwarding a start pulse signal SP from the controller 4. The start pulse signal SP is outputted from a terminal of the controller 4, and is shifted by the shift register circuit 41 in accordance with a clock signal CK.

When eight source driver sections 11 are used for example, the start pulse signal SP shifted by the shift register circuit 41 is forwarded sequentially to the shift register circuit 41 of the eighth source driver section 11 positioned at the eighth stage.

Note that, each of blocks (each of the shift register circuit 41 to the output circuit 46) is constituted of n stages so as to correspond to first to n-th source electrodes of the liquid crystal panel 8. In synchronism with outputs from each stage of the shift register circuit 41, the display data D latched by the input latch circuit 47 are temporarily stored in a corresponding stage of a sampling memory circuit 42, and is outputted to a corresponding stage of the next hold memory circuit 43.

When n-sets of display data D are inputted from the sampling memory circuit 42 in one horizontal synchronization period, the hold memory circuit 43 fetches the display data D from the sampling memory circuit 42 in accordance with the horizontal synchronization signal LS (also referred to as a latch signal) from the controller 4, so as to output the display data D to a next hold memory circuit 43. Further, the hold memory circuit maintains the display data D until a next horizontal synchronization signal LS is inputted. Operations thereafter are as described above.

Note that, the controller 4 repeatedly transmits the display data D to the input latch circuit 47. Thus, a potential corresponding to the display data D is periodically written on the liquid crystal panel 8, so that display made in the liquid crystal panel 8 is maintained.

As described later, the reference voltage generating circuit 48 generates 64 patterns of reference voltages with respect to liquid crystal driving voltage terminals of red, green, and blue, so as to generate intermediate voltages for gradation display. A voltage VR inputted to the circuit 48 is supplied from an external liquid crystal driving power source.

The DA conversion circuit 45 converts each of 6-bit display data signals (digital signals) of RGB, outputted from the hold memory circuit 43, that have been converted by the level shifter circuit 4, into an analog signal in accordance with 64 patterns of the intermediate voltages, so as to output the display data signals to the output circuit 46.

The output circuit 46 amplifies the analog signal of 64 levels so as to output the amplified analog signal to the liquid crystal panel 8 as a gradation display voltage.

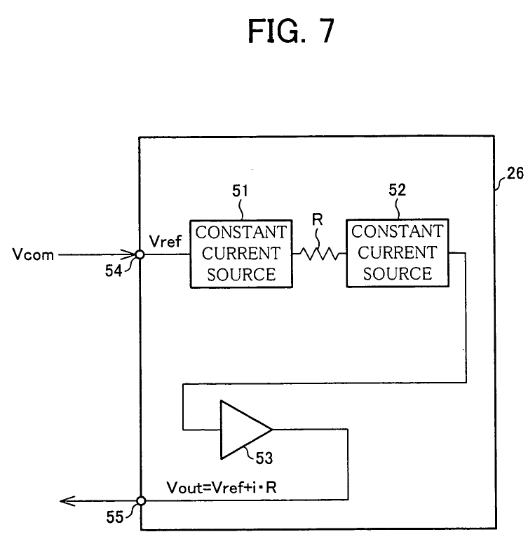

FIG. 7 is a block diagram schematically showing an example of how the Vcom adjustment circuit 26 of each source driver section 11 is arranged. The Vcom adjustment circuit 26 includes a single resistance element R for causing a voltage to drop, two constant current sources 51 and 52, and a buffer amplifier 53. Making use of the voltage drop caused by applying a current to the resistance element R, the Vcom adjustment circuit 26 shifts the inputted voltage up or down merely by a constant voltage, thereby adjusting a Vcom voltage. The Vcom adjustment circuit 26 arranged in this manner operates as follows.

To an input terminal 54 of the Vcom adjustment circuit 26, for example, a voltage Vcom (Vref) which functions as a reference voltage is supplied. Further, in a case of obtaining an output voltage higher or lower than the reference voltage Vcom (Vref), a current that the constant current sources 51 and 52 cause to flow to the resistance element R is varied. Making use of the voltage drop caused by the resistance element R, the output terminal 55 outputs a voltage Vout obtained by shifting the inputted voltage up or down corresponding to the voltage drop caused by the resistance element R.

That is, in the case of obtaining the output voltage Vout higher than the reference voltage Vcom (Vref), the voltage is adjusted so that Vout=Vref+i·R, or in the case of obtaining the output voltage Vout lower than the reference voltage Vcom (Vref), the voltage is adjusted so that Vout=Vref−i·R.

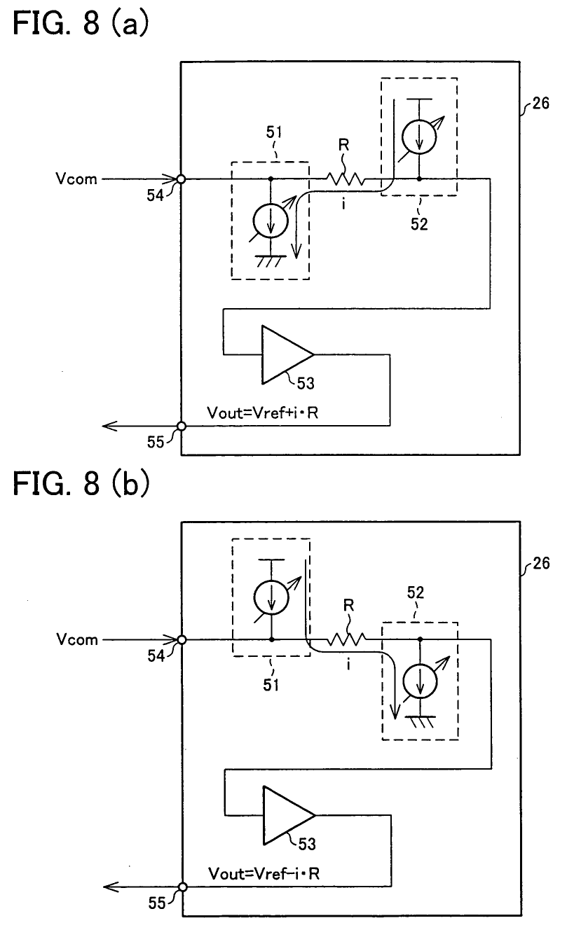

FIG. 8(a) and FIG. 8(b) show how a voltage the constant current sources 51 and 52 cause to flow in the resistance element R varies in the case of obtaining the output voltage Vout higher than the reference voltage Vcom (Vref) (FIG. 8(a)) and in the case of obtaining the output voltage Vout lower than the reference voltage Vcom (Vref) (FIG. 8(b)).

In this case, as shown in FIG. 8(a), the constant current source 51 positioned nearer to the input terminal 54 than the resistance element R is grounded, and the constant current source 52 positioned nearer to the output terminal 55 than the resistance element R is connected to a power source, so that the resistance element R allows a current i to flow from the constant current source 52 to the constant current source 51 in a forward direction. As a result, the output voltage Vout outputted from the output terminal 55, in the case where the reference voltage Vcom (Vref) is inputted from the input terminal 54, becomes a voltage, higher than the reference voltage Vcom (Vref) so as to correspond to the voltage drop caused by the resistance element R, which is such that Vout=Vref+i·R.

While, as shown in FIG. 8(b), the constant current source 51 is connected to the power source, and the constant current source 52 is grounded, so that the resistance element R allows a current i to flow from the constant current source 51 to the constant current source 52 in a backward direction. As a result, the output voltage Vout outputted from the output terminal 55, in the case where the reference voltage Vcom (Vref) is inputted from the input terminal 54, becomes a voltage, lower than the reference voltage Vcom (Vref) so as to correspond to the voltage drop caused by the resistance element R, which is such that Vout=Vref−i·R.

In each Vcom adjustment circuit 26, the current value is switchable into plural values in the constant current sources 51 and 52, and the connection is switchable so as to be grounded or to be connected to the power source. Thus, by controlling the switching operations in accordance with the adjustment data (DL), it is possible to finely adjust the counter electrode voltages.

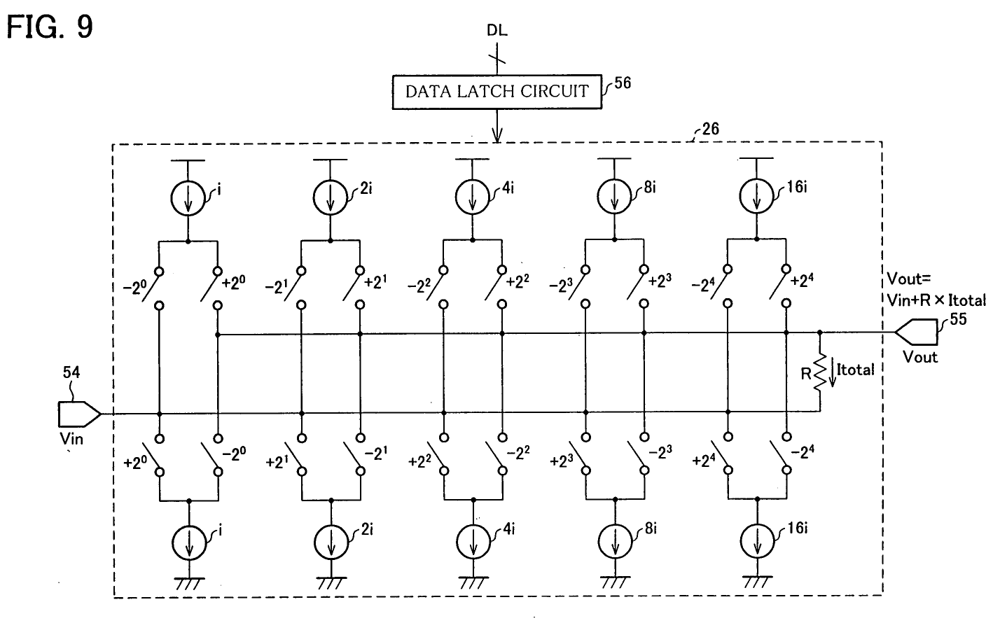

Note that, the adjustment data is inputted from the outside to a data latch circuit 56 (see FIG. 9) of the Vcom adjustment circuit 26 so as to be latched. The data latch circuit 56 may be constituted of a nonvolatile memory such as a flash memory and FRAM.

FIG. 9 shows a circuit arrangement of a constant current source section, corresponding to the constant current sources 51 and 52 of the Vcom adjustment circuit 26 (not only the constant current sources but also the resistance element R), which can switch the current value and can switch so as to be grounded or be connected to the power source.

The constant current source section is connected to the power source, and includes five constant current sources i, 2i, 4i, 8, and 16i, each of which generates a current 2⁽ⁿ⁻¹⁾i weighted by 2⁽ⁿ⁻¹⁾ where n is a positive integer. Further, each constant current source 2⁽ⁿ⁻¹⁾i is connected to the one end of the resistance element R and the output terminal 55 via a switch+2⁽ⁿ⁻¹⁾ which is turned ON by a control signal of +2⁽ⁿ⁻¹⁾. Further, the constant current source 2⁽ⁿ⁻¹⁾i is connected to the other end of the resistance element R and the input terminal 54 via a switch−2⁽ⁿ⁻¹⁾ which is turned ON by a control signal of −2⁽ⁿ⁻¹⁾.

Further, the constant current source is grounded, likewise, and includes five constant current sources i, 2i, 4i, 8i, and 16i, each of which generates a current 2⁽ⁿ⁻¹⁾i weighted by 2⁽ⁿ⁻¹⁾ where n is a positive integer. Further, each constant current source 2⁽ⁿ⁻¹⁾i is connected to the other end of the resistance element R and the input terminal 54 via the switch+2⁽ⁿ⁻¹⁾ which is turned ON by the control signal of +2⁽ⁿ⁻¹⁾. Further, the constant current source 2⁽ⁿ⁻¹⁾i is connected to the one end of the resistance element R and the output terminal 55 via the switch−2⁽ⁿ⁻¹⁾ which is turned ON by a control signal of −2⁽ⁿ⁻¹⁾.

That is, in the constant current source section, the constant current source 2⁽ⁿ⁻¹⁾i which is connected to the input terminal 54 via the switch +2⁽ⁿ⁻¹⁾ or the switch −2⁽ⁿ⁻¹⁾functions as the constant current source 51 of FIG. 8(a) and FIG. 8(b), and the constant current source 2⁽ⁿ⁻¹⁾i which is connected to the output terminal 55 via the switch +2⁽ⁿ⁻¹⁾ or the switch −2⁽ⁿ⁻¹⁾ functions as the constant current source 52 of FIG. 8(a) and FIG. 8(b). Further, in accordance with the adjustment data, i.e., multi-bit digital data of signed binary, latched by the data latch circuit 56, which is expressed in terms of a complementary expression based on 2, ON/OFF of each switch +2⁽ⁿ⁻¹⁾ and ON/OFF of each switch −2⁽ⁿ⁻¹⁾ are controlled, so that it is possible to switch the voltage value concerning the constant current sources 51 and 52, and to switch the connection of constant current sources 51 and 52 so as to be connected to the power source or be grounded.

According to the foregoing arrangement, it is possible to vary a value and a direction of the current flowing in the resistance element R, so that it is possible to output the voltage Vout obtained by shifting the input voltage Vin up or down by several stages so as to correspond to the drop of the voltage flowing in the resistance element R. This function is exemplified as follows.

The following description will be made on the assumption that the adjustment data (DL) is 6-bit data. In accordance with the adjustment data indicated by 6 bits in this manner, it is possible to perform adjustment with 64 levels ranging from −32 to +31 levels.

In FIG. 9, the constant current sources i, 2i, 4i, 8i, and 16i respectively generate the current values i, 2i, 4i, 8i, and 16i, each of which is weighted by 2⁽ⁿ⁻¹⁾. Further, the switch +2⁽ⁿ⁻¹⁾ and the switch −2⁽ⁿ⁻¹⁾ are turned ON/OFF in accordance with the adjustment data (DL). The following description will explain how the Vcom adjustment circuit 26 operates on the basis of the 6-bit adjustment data.

A case where the adjustment data (DL) is “+1:(000001)” is described as a first case. In this case, merely two switches+2⁰ are turned ON, and all the other switches are turned OFF. This condition is shown in FIG. 8(a).

That is, a current “I total” which flows to the resistance element R is the same as in the constant current source i, and flows in a forward direction. Thus, the output voltage Vout becomes higher than the inputted reference voltage Vin so as to correspond to the voltage drop caused by the resistance element R, so that it is possible to obtain such an output voltage that Vout=Vin+i×R. This is a voltage higher than the inputted reference voltage Vin by (i×R).

Further, a case where the adjustment data (DL) is “−9:(101001)”—is described as another case. In this case, four switches: two switches −2³ and two switches −2⁰ are turned ON, and all the other switches are turned OFF. This condition is shown in FIG. 8(b).

That is, a current “I total” which flows to the resistance element R becomes 9i which is a total of (i) a current of the constant current source i and (ii) a current of the constant current source 8i, and flows in a backward direction. Thus, the output voltage Vout becomes lower than the inputted reference voltage Vin so as to correspond to the voltage drop caused by the resistance element R, so that it is possible to obtain such an output voltage that Vout=Vin−9i×R. This is a voltage lower than the input reference voltage Vin by 9 times of (i×R).

That is, by using multi-bit digital data of signed binary expressed in terms of a complementary expression based on 2 as the adjustment data, it is possible to cause (i) a bit number n and (ii) a weight (scale factor) 2⁽ⁿ⁻¹⁾ of a value of a current flowing to the resistance element R to correspond to each other via the switches+2⁽ⁿ⁻¹⁾ and −2⁽ⁿ⁻¹⁾. Thus, it is possible to obtain an adjustment amount whose scale factor corresponds to the adjustment data (DL). That is, it is possible to easily designate the adjustment amount of the reference value in accordance with the adjustment data (DL).

Further, the liquid crystal display device 1 of the present embodiment solves such a problem that: liquid crystal is aligned so asymmetrically particularly in an up-and-down direction in the liquid crystal panel, so that a view angle is narrowed. Thus, in the liquid crystal display device 1, the counter electrodes 7 are divided into a plurality of groups, and the counter electrode voltages C1, C2, C3, . . . outputted by the Vcom adjustment circuit 26 provided in the source driver are applied to arbitrary lines of the counter electrodes 7. Thus, it is possible to vary a luminance characteristic so as to obtain a most appropriate view at each angular position in viewing, so that it is possible to correct color variation caused by difference in the angular position in viewing.

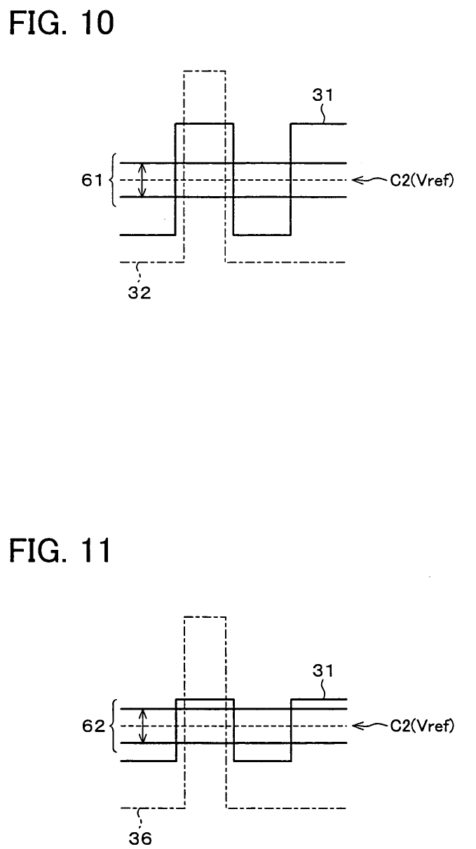

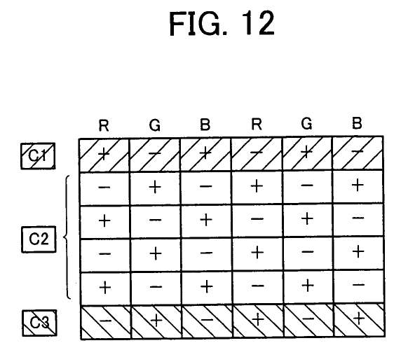

FIG. 10 and FIG. 11 show an example of a liquid crystal driving waveform. In FIG. 10 and FIG. 11, as in the case shown in FIG. 4 and FIG. 5, each of 31 and 35 is a driving waveform of an output from the source driver 2, and each of 32 and 36 is a driving waveform of an output from the gate driver 3.

Further, each of 61 and 62 is a polarity driving potential (counter electrode voltage C) applied to the counter electrode 7, and the counter electrode voltages C1 to C3 outputted from the Vcom adjustment circuit 26 are applied to the counter electrodes 7 of three groups: the first group 7(A) to the third group 7(C). That is, the counter electrode voltage C1 is applied to the counter electrodes 7 of the first group 7(A), and the counter electrode voltage C2 is applied to the counter electrodes 7 of the second group 7(B), and the counter electrode voltage C3 is applied to the counter electrodes 7 of the third group 7(C).

The counter electrode voltage C2 (Vref) which functions as a standard voltage is applied to the second group 7(B). Further, as to the counter electrode voltage C1 applied to the first group 7(A) and the counter electrode voltage C3 applied to the third group 7(C), the one is set to be higher than the counter electrode voltage C2 (Vref) which functions as a standard voltage, and the other is set to be lower than the counter electrode voltage C2. Thus, in the up-and-down direction with respect to the liquid crystal panel 8, it is possible to widely vary the view angle characteristic. Note that, each of the counter electrode driving potentials 61 and 62 shown in FIG. 10 and FIG. 11 is described as a potential having a predetermined width so as to correspond to the counter electrode voltages C1 to C3.

Here, the following description explains comparison between the aforementioned case of the liquid crystal driving waveform shown in FIG. 4 and the aforementioned case of the liquid crystal driving waveform shown in FIG. 10 for example.

In the case of the liquid crystal driving waveform shown in FIG. 4, the TFT 23 is ON merely at a period in which a level of the driving waveform 32 of the gate driver 4 is high, so that a voltage difference between the driving waveform 31 of the source driver 3 and the potential 33 of the counter electrode 7 is applied to the pixel electrode 21. Thereafter, a level of the driving waveform 32 of the gate driver 4 becomes low, so that the TFT 23 is turned OFF. In this case, the pixel capacitor 22 exists in the pixel, so that the foregoing voltage is maintained.

In the case of the liquid crystal driving waveform shown in FIG. 10, basic operations such as ON/OFF of the TFT 23 are the same. However, the same potential is not given to all the counter electrodes 7, but different potentials are applied to different groups of the counter electrode 7 for example, so that the case of FIG. 10 is different from the case of FIG. 4 in terms of a display condition of the liquid crystal panel 8.

FIG. 12 shows an example of a condition of a potential in each pixel dot in the case where different counter electrode voltages C1 to C3 are applied from the Vcom adjustment circuit 26 to the counter electrodes 7 of the first group 7(A) to the third group 7(C).

In FIG. 12, the counter electrode voltage C2 which functions as a standard voltage is supplied to the pixel dots that are not positioned in a shaded area (pixel dots exist in four rows between an uppermost row and a lowermost row in FIG. 12), and the counter electrode voltages C1 and C3 that are different from the counter electrode voltage C2 are supplied to pixel dots that are positioned in the shaded area (pixel dots positioned in the uppermost row and the lowermost row in FIG. 12). Note that, + and − in FIG. 12 show that the polarities of the voltages applied to the pixel dots are inverted by a dot inversion process. Further, a single square represents a single pixel dot.

Further, FIG. 13 shows an example of the pixel dots corresponding to two sequential frames (frame n, frame n+1) in the driving condition of FIG. 12, and shows a case where the counter electrode voltage C is varied for each frame.

The liquid crystal display device 1 is controlled so that the counter electrode voltage C is varied for each group of the counter electrodes 7 as described above, so that it is possible to display an image which can be appropriately viewed at a wide visual angle in the up-and-down direction with respect to the liquid crystal panel 8.

In the foregoing example, two types of counter electrode voltages C whose potentials are different from that of the counter electrode voltage C functioning as a standard voltage are applied to arbitrary lines of the counter electrodes 7 within one frame, so that the visual angle is widened in the up-and-down direction with respect to the liquid crystal panel 8. However, it may be so arranged that three or more types of counter electrode voltages C are applied to arbitrary lines of the counter electrodes 7 with a single counter electrode voltage C being regarded as a standard voltage.

Next, the following description shows an example where the arrangement of the present invention is applied to a multi-domain liquid crystal panel.

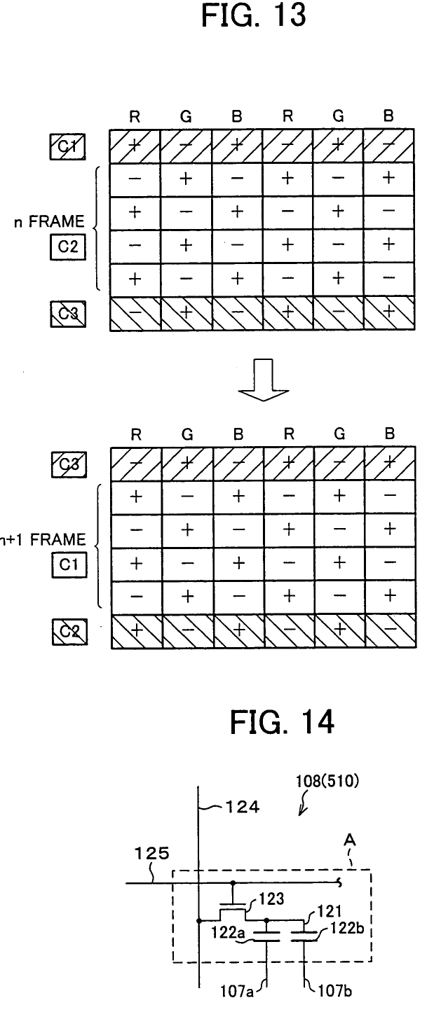

As shown in FIG. 14, in a multi-domain liquid crystal panel 108, a source line 124, a gate line 125, and a TFT 123 are disposed in the same manner as the source line 24, the gate line 25, and the TFT 23. However, the multi-domain liquid crystal panel 108 includes two pixel capacitors 122a and 122b, and a pixel electrode 121 connected to the pixel capacitors 122a and 122b is connected to a drain of the TFT 123. Note that, the pixel electrode 121, the pixel capacitors 122a and 122b, and the TFT 123 constitute a liquid crystal display element A corresponding to a single pixel.

The multi-domain liquid crystal panel 108 is arranged so that: in a single liquid crystal display element A, counter electrodes are divided into (i) a counter electrode 107a corresponding to the pixel capacitor 122a and (ii) a counter electrode 107b corresponding to the pixel capacitor 122b, and these counter electrodes are respectively controlled.

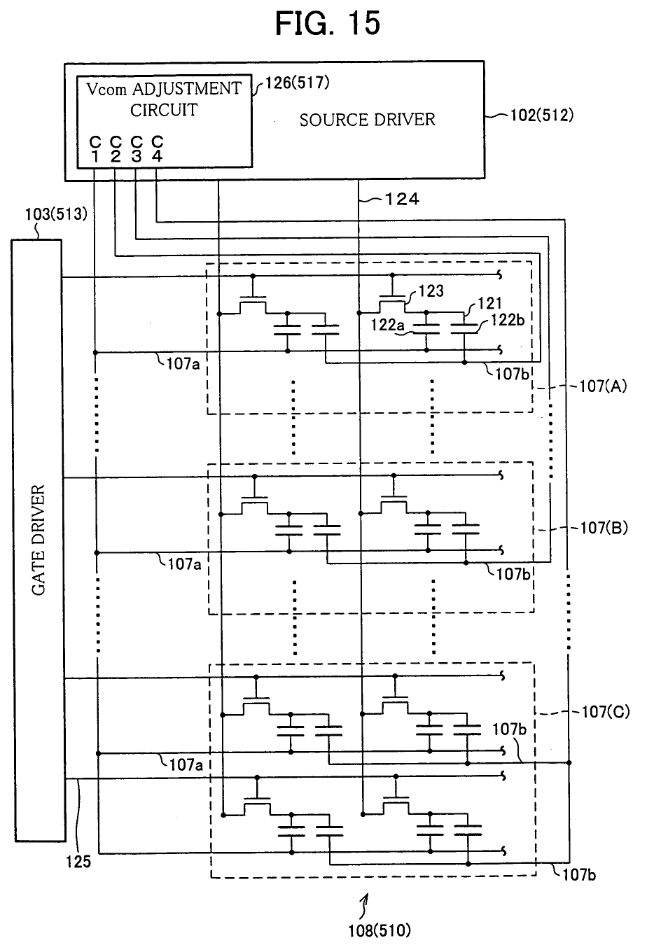

FIG. 15 shows an example of how the multi-domain liquid crystal panel 108 is arranged. In the multi-domain liquid crystal panel 108, as in the liquid crystal panel 8, the counter electrodes 107a and 107b are sequentially grouped for one or e gate lines 125 (e is a positive integer). Alternatively, the counter electrodes 107a and 107b are grouped for a plurality of gate lines 125 adjacent to each other. Here, as in the case of the liquid crystal panel 8, the counter electrodes 107a and 107b are divided into a first group 107(A), a second group 107(B), and a third group 107(C) for example.

Further, the multi-domain liquid crystal panel 108 includes a source driver 102 corresponding to the source driver 2 and a gate driver 103 corresponding to the gate driver 3, and the source driver 102 has a Vcom adjustment circuit 126. The Vcom adjustment circuit 126 is arranged so as to correspond to the Vcom adjustment circuit 26, and can output at least counter electrode voltages C1 to C4. The Vcom adjustment circuit 126 can adjust values of the outputted counter electrode voltages C1 to C4 as in the Vcom adjustment circuit 26.

In the multi-domain liquid crystal panel 108, the counter electrode voltage C1 is supplied from the Vcom adjustment circuit 126 so as to be shared by the counter electrodes 107a of the respective groups. Further, the Vcom adjustment circuit 126 supplies the counter electrode voltage C2 to the counter electrode 107b of the first group 107(A), and supplies the counter electrode voltage C3 to the counter electrode 107b of the second group 107(B), and supplies the counter electrode voltage C4 to the counter electrode 107b of the third group 107(C).

In this manner, the multi-domain liquid crystal panel 108 is arranged so that the counter electrode voltages C applied to the counter electrodes 107b are respectively controlled. Thus, as in the liquid crystal panel 8, it is possible to widen the visual angle in the up-and-down direction with respect to the multi-domain liquid crystal panel 108.

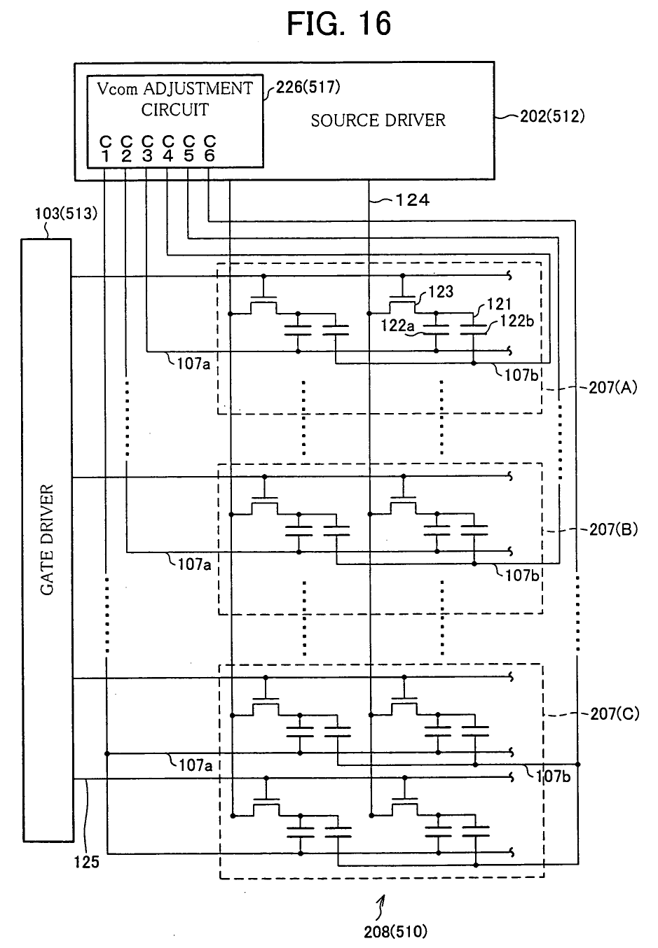

FIG. 16 shows a multi-domain liquid crystal panel 208 arranged so that: the counter electrodes 107a and 107b are sequentially grouped for one or e gate lines 125 (e is a positive integer), and the counter electrode voltages C applied to the counter electrode 107a and the counter electrodes 107b are respectively controlled for each group.

In this case, a Vcom adjustment circuit 226 of a source driver 202 is arranged so as to correspond to the Vcom adjustment circuit 26, and can output at least counter electrode voltages C1 to C6. The Vcom adjustment circuit 226 can adjust values of the counter electrode voltages C1 to C6.

In the multi-domain liquid crystal panel 208, the counter electrodes 107a and 107b are divided into a first group 207(A), a second group 207(B), and a third group 207(C) for example. In the multi-domain liquid crystal panel 208, the Vcom adjustment circuit 226 supplies the counter electrode voltage C3 to the counter electrode 107a of the first group 207(A), and supplies the counter electrode voltage C2 to the counter electrode 107a of the second group 207(B), and supplies the counter electrode voltage C1 to the counter electrode 107a of the third group 207(C). Further, the Vcom adjustment circuit 226 supplies the counter electrode voltage C4 to the counter electrode 107b of the first group 207(A), and supplies the counter electrode voltage C5 to the counter electrode 107b of the second group 207(B), and supplies the counter electrode voltage C6 to the counter electrode 107b of the third group 207(C).

In this manner, the multi-domain liquid crystal panel 208 is arranged so that the counter electrode voltages C applied to the counter electrodes 107a and 107b are respectively controlled for each group. Thus, as in the liquid crystal panel 8, it is possible to widen the visual angle in the up-and-down direction with respect to the multi-domain liquid crystal panel 208.

[Embodiment 2]

The following description will explain another embodiment of the present invention with reference to drawings.

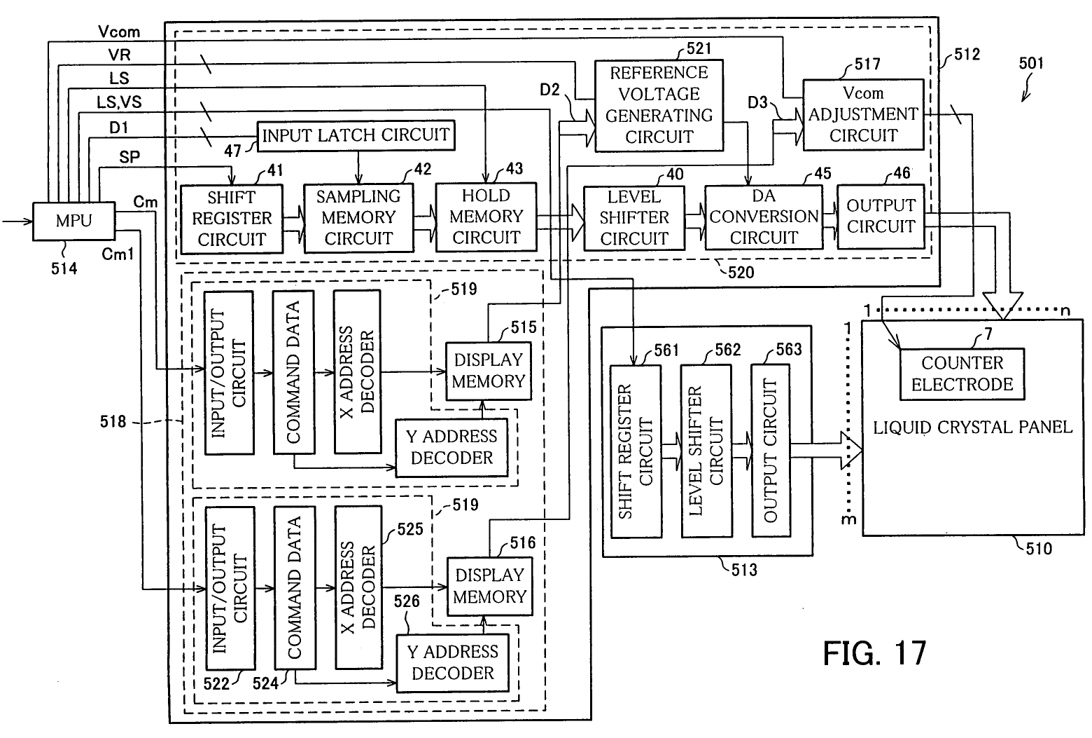

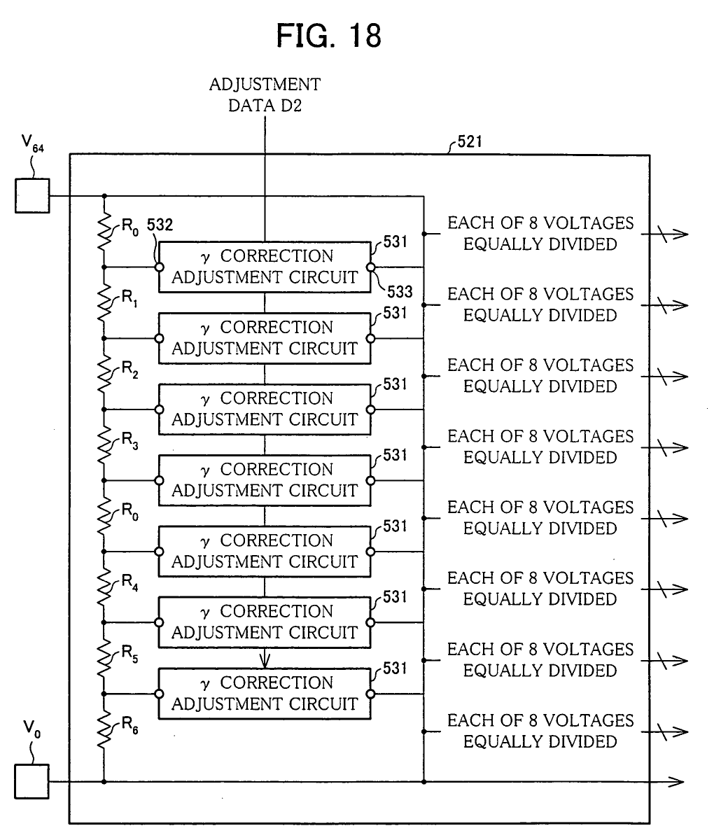

FIG. 17 is a block diagram showing a structure of a liquid crystal display device (TFT liquid crystal module) 501 of the present embodiment. Note that, FIG. 17 shows merely main components and signal paths, and does not show a power source circuit and paths of partial signals such as a clock signal, a reset signal, and a selection signal.

The liquid crystal display device 501 includes a liquid crystal panel 510 (having a counter electrode 7), a source driver 512, a gate driver 513, and an MPU (micro processor unit) 514 which functions as a control circuit.

The liquid crystal panel 510 includes a TFT-type pixel in which n source lines 24 and m gate lines 25 are formed so that (horizontal direction n pixels)×(vertical direction m pixels).

Note that, a single line in which pixels are disposed in a horizontal direction is referred to as “column”, and a single line in which pixels are disposed in a vertical direction is referred to as “row”. Here, n=1028×RGB and m=900, and an image based on 64 gradation (6 bits) ranging from 0 gradation to 63 gradation is displayed in each pixel. Note that, in each column, pixels respectively displaying colors of R (red), G (green), and B (blue) are repeatedly disposed.

The liquid crystal panel 510 is arranged as shown in FIG. 3 for example, and the counter electrodes 7 are sequentially grouped for one or e gate lines 25 (e is a positive integer)(groups: a first group 7(A), a second group 7(B), and a third group 7(C)) as described above.

In this case, the Vcom adjustment circuit 517 is arranged so as to correspond to the Vcom adjustment circuit 26. The Vcom adjustment circuit 517 supplies counter electrode voltages C respectively to the counter electrodes 7 of the groups. That is, as shown in FIG. 1, the counter electrode voltage C1 is supplied to the first group 7(A), and the counter electrode voltage C2 is supplied to the second group 7(B), and the counter electrode voltage C3 is supplied to the third group 7(C). Thus, it is possible to widen the visual angle in the up-and-down direction with respect to the liquid crystal panel 510 as in the foregoing arrangements.

Further, the liquid crystal panel 510 may be arranged in the same manner as in the multi-domain liquid crystal panel 108 shown in FIG. 14 and FIG. 15. In this case, the Vcom adjustment circuit 517 is arranged so as to correspond to the Vcom adjustment circuit 126.

In such arrangement, as in the multi-domain liquid crystal panel 108, the counter electrodes 107a and 107b are divided into a first group 107(A), a second group 107(B), and a third group 107(C), and the Vcom adjustment circuit 517 supplies the counter electrode voltage C3 so as to be shared by the counter electrodes 107a of the respective groups. Further, the Vcom adjustment circuit 517 supplies the counter electrode voltage C4 to the counter electrode 107b of the first group 107(A), and supplies the counter electrode voltage C5 to the counter electrode 107b of the second group 107(B), and supplies the counter electrode voltage C6 to the counter electrode 107b of the third group 107(C). Thus, it is possible to widen the visual angle in the up-and-down direction with respect to the liquid crystal panel 510 as in the foregoing arrangements.

Further, the liquid crystal panel 510 may be arranged in the same manner as in the multi-domain liquid crystal panel 208. In this case, the Vcom adjustment circuit 517 is arranged so as to correspond to the Vcom adjustment circuit 226.

In such arrangement, the liquid crystal panel 510 is arranged so that: as in the multi-domain liquid crystal panel 208, the counter electrodes 107a and 107b are divided into a first group 207(A), a second group 207(B), and a third group 207(C), and the Vcom adjustment circuit 517 supplies the counter electrode voltage C3 to the counter electrode 107a of the first group 207(A), and supplies the counter electrode voltage C2 to the counter electrode 107a of the second group 207(B), and supplies the counter electrode voltage C1 to the counter electrode 107a of the third group 207(C). Further, the Vcom adjustment circuit 517 supplies the counter electrode voltage C4 to the counter electrode 107b of the first group 107(A), and supplies the counter electrode voltage C5 to the counter electrode 107b of the second group 107(B), and supplies the counter electrode voltage C6 to the counter electrode 107b of the third group 107(C). Thus, it is possible to widen the visual angle as in the foregoing arrangements.

Examples of its liquid crystal driving waveform include the liquid crystal driving waveforms shown in FIG. 10 and FIG. 11.

The source driver 512 and the gate driver 513 are connected to the liquid crystal panel 510, and the source driver 512 and the gate driver 513 are connected to the MPU 514.

Note that, in an example shown in FIG. 17, it is so arranged that the liquid crystal panel 510 is driven by a single source driver 512 and a single gate driver 513. However, each of the source driver 512 and the gate driver 513 is constituted of a one-chip LSI, or a plurality of LSIs. In this manner, it is possible to vary the arrangement thereof.

The MPU 514 outputs a horizontal synchronization signal LS, a start pulse signal SP, a reference voltage Vcom (Vref), an original voltage VR, display data D1, and a display memory control signal Cm to the source driver 512.

The source driver 512 includes a peripheral circuit 518, a reference voltage generating circuit (reference voltage generating means) 521, and a source driver section 520.

The peripheral circuit 518 stores static image data and character display data in display memories 515 and 516, and controls their reading operation. The peripheral circuit 518 includes: two circuits 519 each of which has an input/output circuit 522, a command decoder 524, an X address decoder (column decoder) 525, and a Y address decoder (row decoder) 526; and display memories 515 and 516.

Each of the display memories 515 and 516 can store display data corresponding to such pixels that horizontal direction n pixels×vertical direction m pixels. Each of the display memories 515 and 516 is constituted of a nonvolatile memory such as a resistor, a flash memory, OPT, EEPROM or FeRAM (ferroelectric memory). Further, each of the display memories 515 and 516 may be a memory having a ROM structure.

Each of the display memories 515 and 516 stores not only the static image data and the character display data but also adjustment data D2 for controlling a gradation display reference voltage and adjustment data D3 for controlling the counter electrode voltage C. That is, the display memory (correction information storage means) 515 stores the adjustment data D2, and the display memory (correction information storage means) 516 stores the adjustment data D3.

The display memory 515 reads the adjustment data D2 in accordance with a display memory control signal Cm outputted from the MPU 514, and the adjustment D2 is inputted to the reference voltage generating circuit 521. Further, the display memory 516 reads the adjustment data D3 in accordance with a display memory control signal Cm1 outputted from the MPU 514, and the adjustment data D3 is inputted to the Vcom adjustment circuit 517.

Note that, the adjustment data D3 is read out when the power source of the liquid crystal driving section is turned ON for example, and the adjustment data D2 is read out in synchronism with every 1 to m scanning signals. In this manner, the adjustment data D2 is read out from the display memory 515 at a timing different from a timing at which the adjustment data D3 is read out from the display memory 516. Thus, FIG. 17 shows two display memories 515 and 516 for convenience in the description. However, a single memory can correspond to the display memories 515 and 516.

Further, FIG. 17 shows a condition under which merely the adjustment data D2 and D3 are dealt in the display memories 515 and 516, but also the static image data and the character display data are dealt. That is, by means of a selector circuit (not shown) provided between the sampling memory circuit 42 and the hold memory circuit 43, (i) a signal outputted from the sampling memory circuit 42 and (ii) read-out data (the static image data and the character display data) outputted from the display memories 515 and 516 are selected, and are inputted to the hold memory circuit 43.

The source driver section 520 corresponds to the source driver section 11 shown in FIG. 6, and is arranged in the same manner as in the source driver section 11, and performs the following operations likewise.

The digital display data D1 transmitted from the MPU 514 is 6-bit data corresponding to each pixel for example, and is temporarily latched by the input latch circuit 47. While, the shift register circuit 41 shifts the start pulse SP inputted from the MPU 514 in synchronism with a forwarding clock (not shown).

In a case where eight source driver sections 520 are used for example, the start pulse SP shifted by the shift register circuit 41 is forwarded to the shift register circuit 41 of the eighth source driver 520 positioned at the eighth stage in a sequential manner.

Note that, each of the shift register circuit 41 to the output circuit 46 is constituted of n stages so as to correspond to n source electrodes ranging from first to n-th source electrodes of the liquid crystal panel 510.

In synchronism with an output from each stage of the shift register circuit 41, the display data D1 that has been latched by the input latch circuit 47 is temporarily stored in a corresponding stage of the sampling memory circuit 42, and the display data D 1 is outputted to a corresponding stage of a hold memory circuit 43 positioned next thereto.

When n sets of display data D1 in one horizontal period is inputted from the sampling memory circuit 42 to the hold memory circuit 43, in response to a horizontal synchronization signal LS (also referred to as a latch signal) outputted from the MPU 514, the display data D1 is fetched from the sampling memory circuit 42, so as to output the display data D1 to a level shifter circuit 44 positioned next thereto. Further, the hold memory circuit 43 retains the display data D1 until a next horizontal synchronization signal LS is inputted. Operations thereafter are as described above.

Note that, the MPU 514 repeatedly transmits the display data D1 to the input latch circuit 47. Thus, a potential corresponding to the display data D1 is periodically written on the liquid crystal panel 510, and display based on the liquid crystal is kept in the liquid crystal panel 510.

The reference voltage generating circuit 521 generates, for example, 64 patterns of reference voltages so as to output the reference voltages to liquid crystal driving voltage output terminals corresponding to colors of red, green, and blue, and generates intermediate voltages for gradation display. An original voltage VR inputted to the circuit 48 is supplied from an external liquid crystal driving power source (not shown) via the MPU 514.

Further, the adjustment data D2 read out from the display memory 515 in accordance with the memory control signal Cm is inputted to the reference voltage generating circuit 521.

The DA conversion circuit 45 converts a voltage selected from the 64 patterns of intermediate voltages into analog signals so as to output the voltages to the output circuit 46 in accordance with 6-bit display data signals (digital) of RGB that have been converted by the level shifter circuit 44.

The output circuit 46 amplifies the analog signals having 64 levels so as to output the analog signals to the liquid crystal panel 510 as gradation display voltages.

FIG. 18 is a block diagram showing a structure of the reference voltage generating circuit 521 of the present embodiment.

The reference voltage generating circuit 521 includes: two voltage input terminals (a lowest voltage input terminal V0 and a highest voltage input terminal V64); eight resistance elements R0 to R7 each of which has a resistance ratio for performing γ correction so as to prepare a reference voltage; and a γ correction adjustment circuit 531 for finely adjusting each reference voltage, obtained by means of the resistance elements R0 to R7, that has been subjected to the γ correction, so as to be higher or lower within a certain range.

Further, there are provided 64 resistors (not shown): eight resistors connected to each other in series are provided between the lowest potential voltage input terminal V0 and an output terminal of the γ correction adjustment circuit 531 adjacent thereto, and eight resistors connected to each other in series are provided between output terminals of the γ correction adjustment circuits 531 adjacent to each other, and eight resistors connected to each other in series are provided between the highest potential voltage input terminal V64 and an output terminal of the γ correction adjustment circuit 531 adjacent thereto. Thus, the reference voltage generating circuit 521 can generate 64 patterns of voltages.

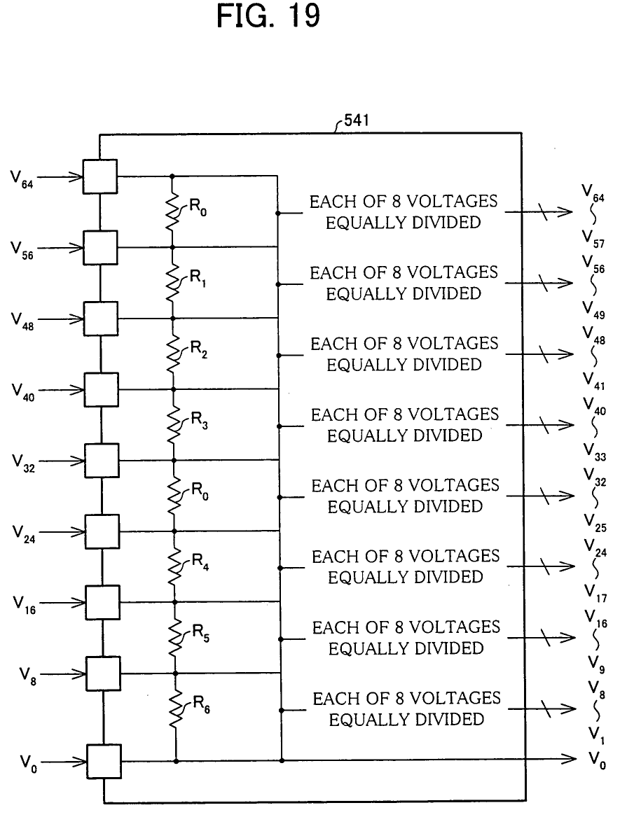

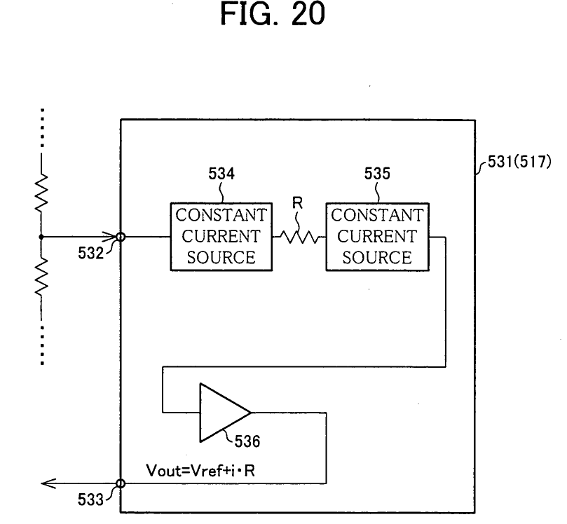

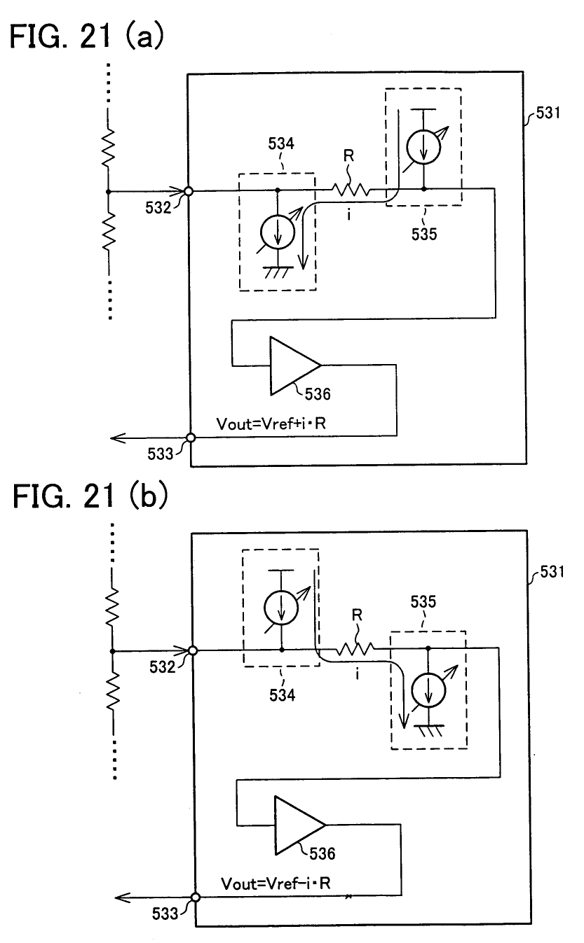

Since the reference voltage generating circuit 521 is arranged in the foregoing manner, it is not necessary to provide nine halftone voltage input terminals V0 to V64 unlike the conventional reference voltage generating circuit 541 for gradation display that is shown in FIG. 19, so that it is possible to generate the intermediate voltage in the reference voltage generating circuit 521.

FIG. 20 is a block diagram schematically showing a structure of the γ correction adjustment circuit 531. The γ correction adjustment circuit 531 includes: a single resistance element R for dropping a voltage; two constant current sources 534 and 535; and a buffer amplifier 546. Further, making use of the voltage drop obtained by causing a current to flow to the resistance element R, the γ correction adjustment circuit 531 adjusts an output voltage by shifting an inputted voltage up or down by a certain voltage. The γ correction adjustment circuit 531 arranged in this manner operates as follows.

For example, a voltage Vref which functions as a reference voltage is supplied to the γ correction adjustment circuit 531. Then, in a case of obtaining an output voltage higher or lower than the reference voltage, the current flowing to the resistance element R is varied by the constant current sources 534 and 535, and the voltage Vout obtained by causing the resistance element R to shift the inputted voltage so as to correspond to the voltage drop is outputted from the output terminal 533 in accordance with the voltage drop caused by the resistance element R.

That is, in a case of obtaining the output voltage Vout higher than the reference voltage Vref, the γ correction adjustment circuit 531 adjusts the voltage so that Vout=Vref+i·R. Alternatively, in a case of obtaining the output voltage Vout lower than the reference voltage Vref, the γ correction adjustment circuit 531 adjusts the voltage so that Vout=Vref−i·R.

FIG. 21(a) shows how the current flowing in the resistance element R is varied by the operations of the constant current sources 534 and 535 in the case of obtaining the output voltage higher than the reference voltage Vref (FIG. 21(a)), and FIG. 21(b) shows how the current flowing in the resistance element R is varied by the operations of the constant current sources 534 and 535 in the case of obtaining the output voltage lower than the reference voltage Vref (FIG. 21(b)).

In this case, as shown in FIG. 21(a), the constant current source 534 positioned nearer to the input terminal 532 than the resistance element R is grounded, and the constant current source 535 positioned nearer to the output terminal 533 is connected to the power source, so that a current i which flows from the constant current source 535 to the constant current source 534 in a forward direction is allowed to flow. As a result, the output voltage Vout outputted from the output terminal 533, in the case where the reference voltage Vref is inputted via the input terminal 532, is higher than the reference voltage Vref so as to correspond to the voltage drop caused by the resistance element R so that Vout=Vref+i·R.

While, as shown in FIG. 21(b), the constant current source 534 is connected to the power source, and the constant current source 535 is grounded, so that a current i which flows from the constant current source 534 to the constant current source 535 in a backward direction is allowed to flow to the resistance element R. As a result, the output voltage Vout outputted from the output terminal 533, in the case where the reference voltage Vref is inputted via the input terminal 532, is lower than the reference voltage Vref with it corresponding to the voltage drop caused by the resistance element R so that Vout=Vref−i·R.

Further, as to the constant current sources 534 and 535 of each γ correction adjustment circuit 531, the current value can be switched into plural values, and the connection can be switched so that the constant current source is grounded or connected to the power source, and these switching operations are controlled in accordance with the adjustment data D2, so that the γ correction voltage obtained by the resistance elements R0 to R7 is finely adjusted. Thus finely adjusted voltage between the reference voltages is equally divided into eight by eight resistors out of the aforementioned 64 resistors, and the divided voltages are outputted to the DA conversion circuit 45.

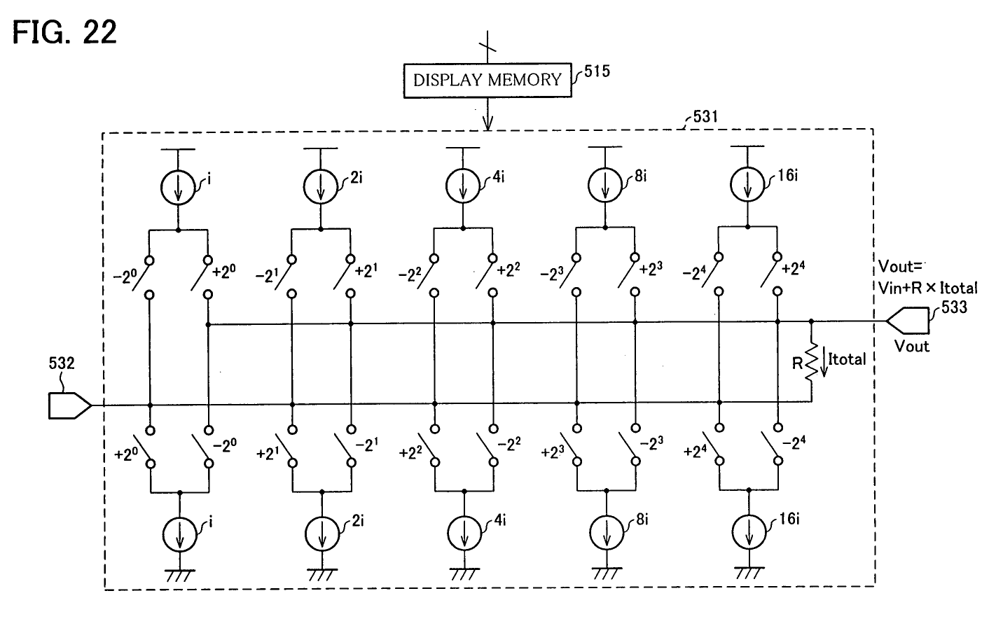

FIG. 22 shows a circuit arrangement of a constant current source section of the γ correction adjustment circuit 531 which realizes (i) the switching operation for switching the current values of the constant current sources 534 and 535 and (ii) the switching operation for causing the constant current sources 534 and 535 to be grounded or to be connected to the power source. The constant current source section includes five constant current sources i, 2i, 4i, 8i, and 16i, connected to the power source, each of which generates a current 2⁽ⁿ⁻¹⁾i weighted by 2(n-1) where n is a positive integer. Further, each constant current source 2⁽ⁿ⁻¹⁾i is connected to one end of the resistance element R and the output terminal 48 via a switch+2⁽ⁿ⁻¹⁾ which is turned ON by a control signal+2⁽ⁿ⁻¹⁾. Further, each constant current source 2⁽ⁿ⁻¹⁾i is connected to the other end of the resistance element R and the output terminal 532 via a switch−2⁽ⁿ⁻¹⁾ which is turned ON by a control signal−2⁽ⁿ⁻¹⁾.

Likewise, the constant current source section includes five constant current sources i, 2i, 4i, 8i, and 16i, grounded, each of which generates a current 2⁽ⁿ⁻¹⁾i weighted by 2⁽ⁿ⁻¹⁾. Further, each constant current source 2⁽ⁿ⁻¹⁾i is connected to the other end of the resistance element R and the output terminal 532 via the switch+2⁽ⁿ⁻¹⁾ which is turned ON by the control signal+2⁽ⁿ⁻¹⁾. Further, each constant current source 2⁽ⁿ⁻¹⁾i is connected to the one end of the resistance element R and the output terminal 533 via the switch−2⁽ⁿ⁻¹⁾ which is turned ON by the control signal−2⁽ⁿ⁻¹⁾.

That is, the constant current source 2⁽ⁿ⁻¹⁾i connected to the input terminal 532 via the switch+2⁽ⁿ⁻¹⁾ or the switch−2⁽ⁿ⁻¹⁾ functions as the constant current source 534 of FIG. 20, and the constant current source 2⁽ⁿ⁻¹⁾i connected to the input terminal 533 via the switch+2⁽ⁿ⁻¹⁾ or the switch−2⁽ⁿ⁻¹⁾ functions as the constant current source 535 of FIG. 20. Further, ON/OFF of each switch+2⁽ⁿ⁻¹⁾ or each switch−2⁽ⁿ⁻¹⁾ is controlled in accordance with adjustment data which is the latched multi-bit digital data of signed binary expressed in terms of a complementary expression based on 2, so that (i) the switching operation for switching the current values of the constant current sources 534 and 535 and (ii) the switching operation for causing the constant current sources 534 and 535 to be grounded or connected to the power source are realized.

By making such arrangement, it is possible to vary a value and a direction of a current flowing in the resistance element R, so that it is possible to output the voltage Vout, obtained by shifting upward or downward the input voltage Vin so as to correspond to each of plural values of the voltage drop caused by the resistance element R. This is detailed as follows by taking a specific example.

The following description is made on the assumption that the adjustment data D2 is 6-bit data. In accordance with the adjustment based on the adjustment data represented by 6 bits, it is possible to adjust the γ correction value with 64 steps ranging from −32 to +31.

In FIG. 22, the constant current sources i, 2i, 4i, 8i, and 16i respectively generate the currents i, 2i, 4i, 8i, and 16i, each of which is weighted by 2⁽ⁿ⁻¹⁾. Further, the switch+2⁽ⁿ⁻¹⁾ and the switch−2⁽ⁿ⁻¹⁾ are turned ON/OFF in accordance with the adjustment data D2. The following description explains how the γ correction adjustment circuit 531 operates in accordance with 6-bit adjustment data.

A case where the adjustment data D2 is “+1:(000001)” is described as a first case. In this case, merely two switches+2⁰ are turned ON, and all the other switches are turned OFF. This condition is shown in FIG. 21(a).

That is, a current “I total” which flows to the resistance element R is the same as in the constant current source i, and flows in a forward direction. Thus, the output voltage Vout becomes higher than the inputted reference voltage Vin with it corresponding to the voltage drop caused by the resistance element R, so that it is possible to obtain such an output voltage that Vout=Vin+i×R. This is a voltage higher than the inputted reference voltage Vin by (i×R).

Further, a case where the adjustment data (DL) is “−9:(101001)” is described as another case. In this case, four switches: two switches −2³ and two switches −2⁰ are turned ON, and all the other switches are turned OFF. This condition is shown in FIG. 21(b).

That is, a current “I total” which flows to the resistance element R becomes 9i which is a total of (i) a current of the constant current source i and (ii) a current of the constant current source 8i, and flows in a backward direction. Thus, the output voltage Vout becomes lower than the inputted reference voltage Vin with it corresponding to the voltage drop caused by the resistance element R, so that it is possible to obtain such an output voltage that Vout=Vin−9i×R. This is a voltage lower than the input reference voltage Vin by 9 times of (i×R).

Also in a case of another adjustment data, in a similar manner as the foregoing operations, the respective switches+2⁽ⁿ⁻¹⁾ and −2⁽ⁿ⁻¹⁾ are turned ON/OFF, so that it is possible to adjust a voltage into 64 steps ranging from −32 to +31, with a voltage of (i×R) for each step, under such condition that the input reference voltage Vin is regarded as a center.

That is, by using the multi-bit digital data of signed binary expressed in terms of a complementary expression based on 2 as the adjustment data, it is possible to make its bit number n correspond to the weight (scale factor) 2⁽ⁿ⁻¹⁾ of a value of a current caused to flow to the resistance element R, via the switches +2⁽ⁿ⁻¹⁾ and −2⁽ⁿ⁻¹⁾. Thus, it is possible to obtain an adjustment amount of the scale factor corresponding to the adjustment data D2. That is, it is possible to easily designate the adjustment amount of the reference value in accordance with the adjustment data.

As described above, the switches+2⁽ⁿ⁻¹⁾ and −2⁽ⁿ⁻¹⁾ are turned ON/OFF in accordance with the adjustment data D2 stored in the display memory 515, so that it is possible to output a voltage in accordance with the adjustment data obtained by adjusting the input voltage.

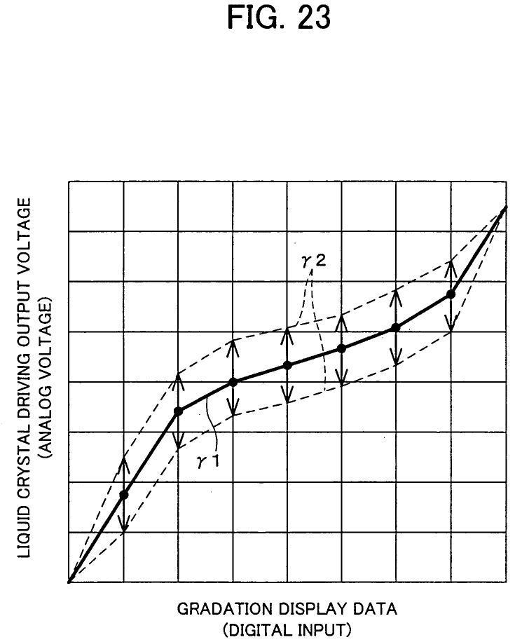

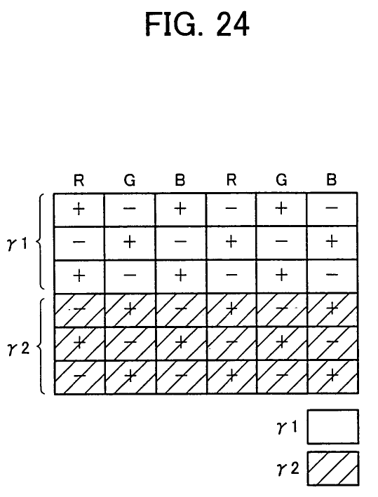

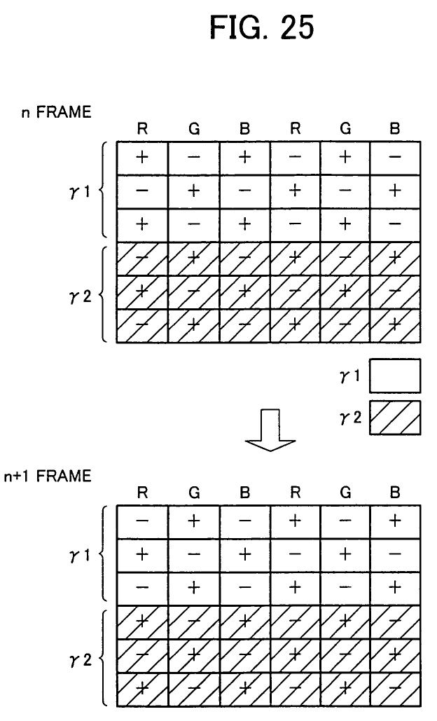

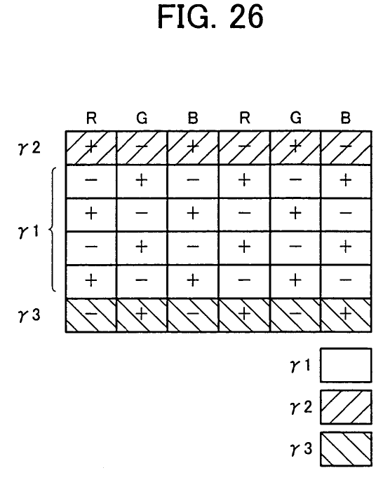

By applying such adjustment to the γ correction value based on the resistance elements R0 to R7, as shown in FIG. 23, it is possible to obtain a gamma conversion characteristic γ1, in which the correction value based on the resistance elements R0 to R7 is centered, and a gamma conversion characteristic γ2, which can be adjusted in accordance with the adjustment data, as characteristics of the liquid crystal driving output voltage. As shown in FIG. 24, by using a different gamma characteristic merely in an arbitrary line in a single image, it is possible to vary the characteristics so that the visual angle corresponds to the most appropriate view.

Note that, on the display memory 515, it is possible to freely rewrite the adjustment data by means of program and the like as required.

FIG. 24 shows an example where the gamma conversion characteristic γ1 and the gamma conversion characteristic γ2 adjusted in accordance with the adjustment data are applied to the liquid crystal display device 501.

In FIG. 24, a portion having no shaded area represents pixel dots each of which receives a signal corresponding to the gamma conversion characteristic γ1 in which the correction value based on the resistance elements R0 to R7 is centered, and a portion having the shaded area represents pixel dots each of which receives a signal corresponding to the gamma conversion characteristic γ2 which is adjusted in accordance with the adjustment data. Note that, a sign such as + and − in the pixel dot represents a characteristic of an applied signal. That is, this example shows the case of the dot inversion driving system, so that the polarity is inverted for each dot (pixel).

Further, FIG. 25 shows an example of a γ characteristic corresponding to two sequential frames of the liquid crystal display device shown in FIG. 24.

In the examples of FIG. 24 and FIG. 25, the two gamma conversion characteristics γ1 and γ2, that are different from each other, are applied to arbitrary lines in a single image, so as to widen the visual angle. However, the gamma characteristic is not limited to the two characteristics, but it is needless to say that it is possible to widely vary the visual angle characteristic by applying three or more gamma characteristics as required.

Here, in the examples of FIG. 24 and FIG. 25, in a case where a voltage having the gamma conversion characteristic γ1 is applied to a centered line and voltages each of which has the same gamma conversion characteristic γ2 are applied to a line positioned on the upper end side and a line positioned on the lower end side for example, the visual angle characteristic is improved, thereby obtaining a wide visual angle. However, in the case where the liquid crystal panel 10 is viewed from an upper direction or from a lower direction, the gamma conversion characteristic is corrected with respect to only one of the upper direction and the lower direction when improving the asymmetric characteristic of liquid crystal aligned in the upper direction or the lower direction (a condition under which the liquid crystal is viewed from the upper direction or a condition under which the liquid crystal is viewed from the lower direction). This is a particular problem here. In this case, a degree to which the visual angle is improved is slightly limited.

Then, in the examples of FIG. 24 and FIG. 25, voltages different from each other in terms of the gamma conversion characteristic are applied to lines positioned on the upper side and to lines positioned on the lower side of the liquid crystal panel 510 respectively so that it is possible to perform the correction in both (i) the case where the liquid crystal panel 510 is viewed from the upper direction and (ii) the liquid crystal panel 510 is viewed from the lower direction. For example, voltages each of which has the gamma conversion characteristic γ1 are applied to upper-half lines, and voltages each of which has the gamma conversion characteristic γ2 are applied to lower-half lines. Thus, it is possible to correct the color variation caused by different angular positions in viewing, and it is possible to obtain a more preferable visual angle characteristic.

FIG. 26 shows an example where voltages respectively having a gamma conversion characteristic γ1, a gamma conversion characteristic γ2, and a gamma conversion characteristic γ3 are applied to the liquid crystal panel 510. In this case, the gamma conversion characteristics γ2 and γ3, that have been adjusted in accordance with the adjustment data, are used with the gamma conversion characteristic γ1 regarded as a reference. Specifically, voltages each of which has the gamma conversion characteristic γ1 are applied to centered lines of the liquid crystal panel 510, and voltages each of which has one of the gamma conversion characteristic γ2 and the gamma conversion characteristic γ3 are applied to lines positioned on the upper side, and voltages each of which has the other of the gamma conversion characteristic γ2 and the gamma conversion characteristic γ3 are applied to lines positioned on the lower side.

In FIG. 26, a portion having no shaded area represents pixel dots each of which receives a signal corresponding to the gamma conversion characteristic γ1 in which the correction values based on the resistance elements R0 to R7 are centered. A portion having the shaded area represents pixel dots each of which receives a signal corresponding to the gamma conversion characteristic γ2 or the gamma conversion characteristic γ3 that has been adjusted in accordance with the adjustment data. Further, a sign such as + and − in the pixel dot represents polarity of an applied signal.

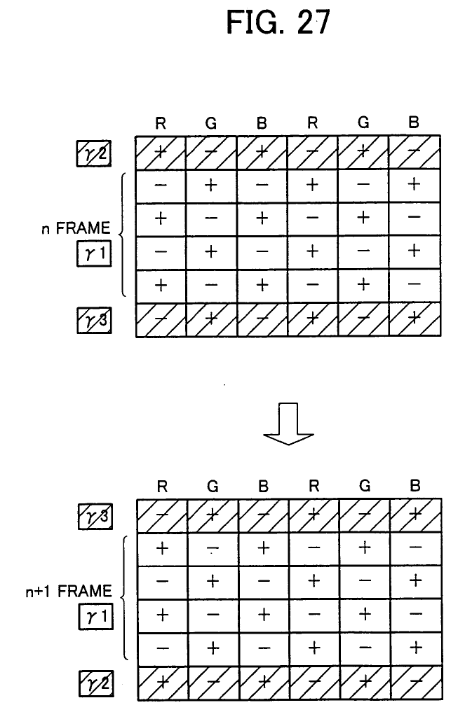

FIG. 27 shows an example of a γ characteristic corresponding to two sequential frames of the liquid crystal display device shown in FIG. 26. Here, a signal voltage, corresponding to each of different gamma conversion characteristics, whose polarity is inverted, is applied to the same pixel (RGB pixel dot arrangement).

Thus, it is possible to keep the balance among the colors of RGB, and it is possible to suppress the image burning caused by fixed polarization of the liquid crystal and the alignment film. Note that, the fixed polarization of the liquid crystal and the alignment film is caused by a residual DC voltage generated by an unbalanced negative signal.

As described above, in the examples of FIG. 26 and FIG. 27, three types of the gamma conversion characteristics γ1, γ2, and γ3 are used, and signal voltages respectively corresponding to the gamma conversion characteristics γ1, γ2, and γ3 are applied to arbitrary lines in a single image. Further, in a next frame, polarities of the signal voltages are inverted. Thus, it is possible to vary the luminance characteristic so that it is possible to obtain the most appropriate view at each angular position in viewing. Thus, it is possible to more appropriately correct the color variation caused by different angular positions in viewing.

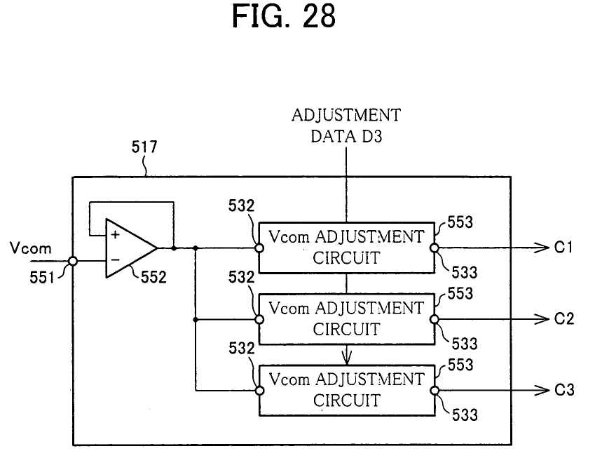

FIG. 28 is a block diagram showing a structure of the Vcom adjustment circuit 517.

The Vcom adjustment circuit 517 includes: an input terminal 551 to which the reference voltage Vcom (Vref) is inputted; a buffer amplifier 552 connected to the input terminal 551; and a plurality of Vcom adjustment section 553 for finely adjusting the reference voltage Vcom higher or lower within a certain range.

The Vcom adjustment section 553 is arranged in the same manner as in the γ correction adjustment circuit 531 illustrated in FIG. 20, so that description thereof is omitted. Further, operations thereof are briefly described with reference to FIG. 20 and FIG. 28.

To the input terminal 532 of the Vcom adjustment circuit 517, for example, a voltage Vcom (Vref) which functions as a reference voltage is supplied from the outside. Further, in a case of obtaining an output voltage higher or lower than the reference voltage Vcom (Vref), a current which the constant current sources 534 and 535 cause to flow to the resistance element R is varied by using the voltage drop caused by the resistance element R. Thus, the output terminal 533 outputs the voltage Vout obtained by shifting the inputted reference voltage Vcom higher or lower so as to correspond to the voltage drop caused by the resistance element R.

That is, in a case of obtaining the output voltage Vout higher than the reference voltage Vcom (Vref), the Vcom adjustment circuit 517 adjusts the voltage so that Vout=Vref+i·R. Alternatively, in a case of obtaining the output voltage Vout lower than the reference voltage Vcom (Vref), the Vcom adjustment circuit 517 adjusts the voltage so that Vout=Vref−i·R.

The output from the Vcom adjustment circuit 517, i.e., the liquid crystal driving waveform containing the counter electrode voltage C is as shown in FIG. 10 and FIG. 11. The Vcom adjustment circuit 517 arranged as shown in FIG. 28 outputs the counter electrode voltages C1 to C3, and the counter electrode voltages C1 to C3 are respectively supplied to the counter electrodes 7 of the first group 7(A) to the third group 7(C) in the circuit shown in FIG. 1 for example.

In this case, the counter electrode voltage C2 which functions as a standard voltage is applied to the second group 7(B), and the counter electrode voltage C1 or C3 which is higher or lower than the counter electrode voltage C2 to the first group 7(A) and the third group 7(C). Thus, it is possible to obtain a wide view in the up-and-down direction with respect to the liquid crystal panel 510.

The gate driver 513 includes a shift register circuit 561, a level shifter circuit 562, and an output circuit 563. In the gate driver 513, a horizontal synchronization signal LS and a vertical synchronization signal VS are inputted to the shift register circuit 561, and the vertical synchronization signal VS is forwarded at the respective stages of the shift register circuit 561 in a sequential manner in accordance with the horizontal synchronization signal LS as a clock.

Outputs from the respective stages of the shift register circuit 561 respectively correspond to first to m-th pixels included in each row of the liquid crystal panel 510, i.e., first to m-th gate electrodes included in each row of the liquid crystal panel 510. Outputs from the respective stages of the shift register circuit 561 are subjected to level conversion performed by the level shifter circuit 562 so as to be pressurized to a voltage which can control a gate of the TFT 23 of each pixel, and the pressurized outputs are subjected to low impedance conversion performed by the output circuit 563, and the level shifter circuit 562 outputs them to the first to m-th gate electrodes of the liquid crystal panel 510. Each of the outputs from the gate driver 513 becomes a scanning signal, and controls ON/OFF of the TFT 23 of each pixel of the liquid crystal panel 510.

Thus, the TFT 23 whose gate is connected to a single gate line (gate electrode) 25 selected on the basis of the scanning signal is turned ON. Further, the gate line 25 is selected in a sequential manner at each horizontal synchronization period, so that the TFTs 23 of the pixels are sequentially turned ON in a vertical direction.

In the pixel having the TFT 23 which is turned ON after being selected on the basis of the scanning signal, a gradation display potential is supplied from the source line (source electrode) 24 to the pixel capacitor 22 provided on the pixel. Thus, the pixel capacitor 22 is charged in accordance with the potential, and when the TFT 23 is turned OFF, the potential is retained in the pixel capacitor 22, so that the gradation display is made in the pixel.

As described above, there are provided (i) control means (reference voltage generating circuit 521) for adjusting the γ correction values of the resistance elements R0 to R7 in accordance with the adjustment data D2 stored in the display memory 515 and (ii) control means (Vcom adjustment circuit 517) for adjusting the counter electrode voltage C in accordance with the adjustment data D3 stored in the display memory 516, and adjustment is performed in each arbitrary line in a single frame, so that it is possible to vary the luminance characteristic so as to obtain the most appropriate view at each angular position in viewing. Thus, it is possible to correct the color variation caused by different angular positions in viewing.

Here, in the present embodiment, the point will be further described as follows.

As to a relationship between a voltage applied to the counter electrode and a view, the visual angle is varied by intensity of a driving voltage applied to the liquid crystal. That is, when the voltage applied to the liquid crystal is varied, an angle at which a liquid crystal molecule slants is varied, and the angle determines the brightness. Thus, the angle which realizes the brightest condition varies depending on the intensity of the gradation voltage applied to the liquid crystal.

For example, when the observer views an image while moving from an upper direction to a lower direction with respect to the image, whole the image is dark at first. However, as the observer's view point comes near to the front of the image, the image becomes bright. When the view point comes to a certain point of the image, a portion which can be most vividly seen is found. After passing the portion, the image becomes dark again. Thus, by increasing or decreasing each gradation voltage, it is possible to vary the angle at which the image is most vividly seen. Note that, as to whether to increase or decrease the gradation voltage, or as to a degree to which each gradation voltage is varied, a characteristic value may be determined depending on types of the liquid crystal. Then, in the present invention, a plurality counter electrodes are prepared so as to correspond to the gradation voltages, and the divided counter electrodes are respectively controlled, so that the display condition is controlled so that the image is evenly observed regardless of an observing direction (angular position in viewing). Thus, the visual angle is widened.

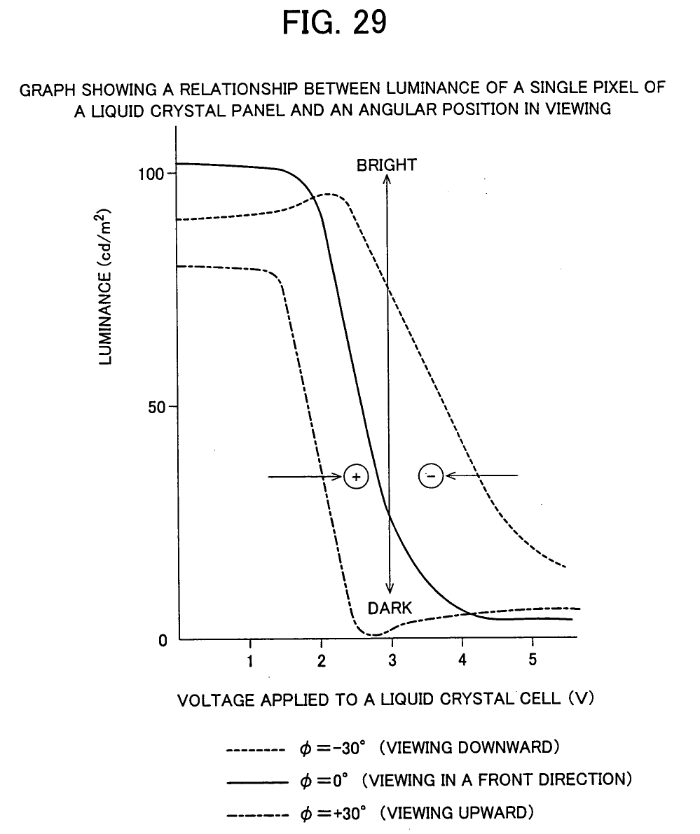

FIG. 29 shows a relationship between the luminance (transmittance) and an angular position in viewing Φ as to a single pixel of the liquid crystal panel. For example, on the assumption that the applied voltage of the liquid crystal cell is 3V, the image is regarded as being brighter when the observer views the pixels downward (Φ=−30°) compared with a case where the observer views the pixels in a front direction (Φ=0), and the image is regarded as being darker when the observer views the pixels upward (Φ=−30°) compared with the case where the observer views the pixels in a front direction (Φ=0).

That is, this brings about such disadvantage that the brightness is uneven in a vertical (up-and-down) direction (direction in which the gate lines are disposed) with respect to the liquid crystal panel. This is disadvantageous in manufacturing a liquid crystal panel which can be viewed from a wide angular position in viewing Φ. Note that, the same disadvantage occurs also in a right-and-left direction with respect to the liquid crystal panel.

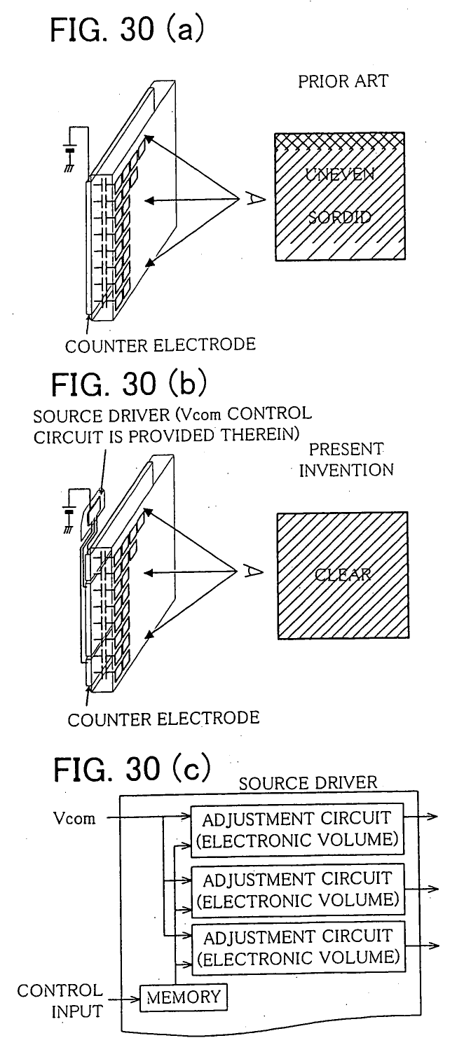

In the case of a large-screen display, as shown in FIG. 30(a), the foregoing disadvantage is obvious, and the visual angle differs depending on whether the observer views the pixels upward or downward. Thus, the present invention is particularly effective in such case, and the arrangement of the source driver shown in FIG. 30(c) can appropriately solve the foregoing conventional problem as shown in FIG. 30(b).

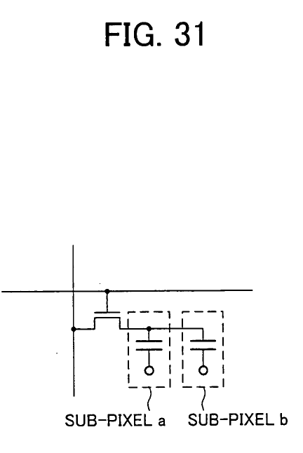

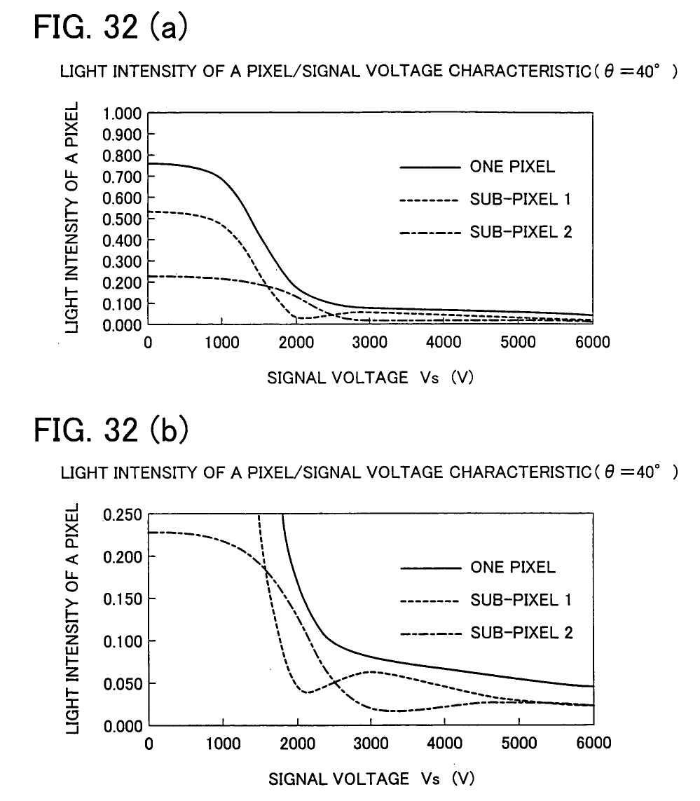

As to the multi-domain liquid crystal, as shown in FIG. 31, the liquid crystal is generally constituted of a sub-pixel a and a sub-pixel b. Each of FIG. 32(a) and FIG. 32(b) shows an example of a characteristic indicating a relationship between a pixel light intensity and signal voltage in case of viewing the multi-domain liquid crystal from a main angular position in viewing.

In FIG. 31, for example, the sub-pixel a shows the same characteristic as in the conventional technique, but the sub-pixel b shows such characteristic that: a low voltage is applied to the liquid crystal layer by using arbitrary means, so that the driving voltage shifts to the side of a high signal voltage (high driving voltage), compared with the sub-pixel a, by an arbitrary voltage. In the present invention, there are provided a plurality of counter electrodes positioned opposite to the sub-pixels a and b, and the counter electrodes are respectively controlled, and the light intensity is controlled so that the image is evenly viewed regardless of the observing direction (angular position in viewing).

The light intensity of a single pixel is obtained by combining the light intensity of the sub-pixel a with the light intensity of the sub-pixel b, so that a peak which causes a gradation inversion phenomenon conventionally occurs on the side of the high signal voltage in each of the sub-pixels a and b.

On the other hand, in the present invention, a characteristic of a single pixel that is obtained by combining characteristics of the sub-pixels a and b with each other is represented by a smooth curve indicative of monotonous decrease because peaks of the sub-pixels counteract each other. Thus, the gradation inversion phenomenon conventionally observed does not occur. Further, the single pixel light intensity/signal voltage curve more gently slants than conventional one. Thus, by slanting the visual line in a main visual angle direction, the light intensity/signal voltage curve shifts to the side of a low signal voltage (low driving voltage). The shift amount of the voltage is not different from conventional one, so that a light intensity difference between the respective levels of the present invention is uniformed compared with the light intensity difference of the respective levels of the conventional arrangement. Thus, black out that is conventionally observed is suppressed, so that the display performance is improved.

As to the static image data and the character display data that are stored in the display memories 515 and 516, the liquid crystal display device does not always forward image data via a controller in displaying an image. In the case of displaying a static image, image data corresponding to one frame is temporarily stored in a memory, and the image data is accessed so as to repeatedly output the image data, so that the liquid crystal display device displays the static image. Further, the liquid crystal display device treats the character display (character stored in the memory in advance) in the same manner.

Next, a relationship between “gamma correction value” and “angular position in viewing” is described as follows.

As described above, the visual angle with respect to the liquid crystal varies depending on the intensity of a voltage applied to the liquid crystal (when the voltage applied to the liquid crystal is varied, an angle at which the liquid crystal molecule slants varies, and the brightness is determined in accordance with the angle). That is, the angle which realizes the brightest image varies depending on the intensity of the driving voltage applied to the liquid crystal.

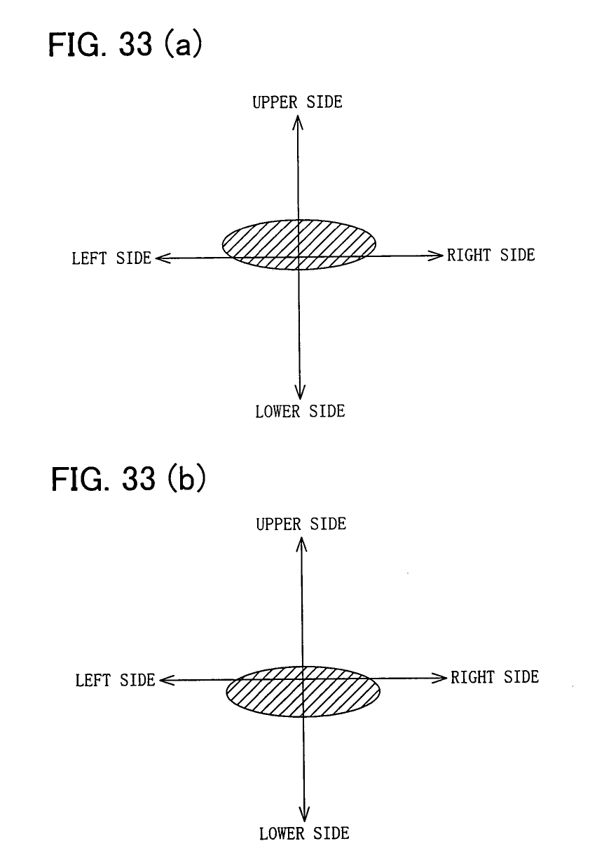

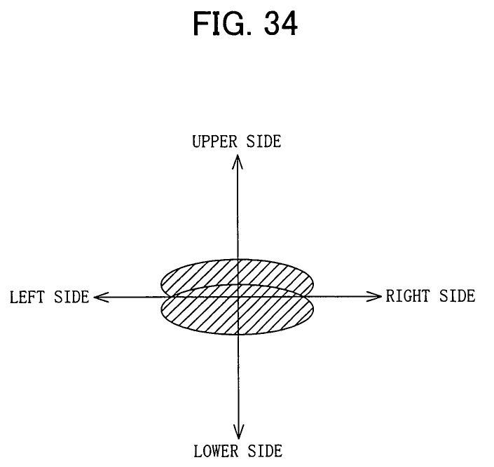

Each of FIG. 33(a) and FIG. 33(b) shows a case where a visual angle distribution in the liquid crystal display device is adjusted to a predetermined condition which differs between the case of FIG. 33(a) and FIG. 33(b). FIG. 34 shows an example of a visual angle distribution expressed by a wide visual angle driving circuit according to the embodiment of the present invention.

For example, when the visual angle distribution such as shown in FIG. 33(a) is obtained by appropriately adjusting distribution of the gradation voltage, an image is vividly seen from an upper direction (oval area). Further, when adjustment is performed as shown in FIG. 33(b), the image is vividly seen from a lower direction (oval area). Thus, they are different from each other in the visual angle.

In such arrangement, in a case of a liquid crystal panel which seems to vary from “dark” to “bright” while the view point is moving from the upper direction to the lower direction with respect to the panel when the observer faces the liquid crystal panel, there is set characteristic data in which the adjustment data are disposed so that the luminance is gradually varied from “bright” to “dark” in numerical order of the gate lines (scanning lines) 25. In accordance with the adjustment data read out from the nonvolatile memory in the numerical order of the gate lines 25, the γ value of the reference voltage is corrected. Thus, only in the case where the observer faces the liquid crystal panel, the luminance in a vertical direction with respect to the liquid crystal panel seems uniformed.

Further, in a case of a liquid crystal panel which seems to vary from “bright” to “dark” while the observer's view point is moving from the lower direction to the upper direction of the liquid crystal panel, there is set characteristic data in which the adjustment data are disposed so that the luminance is gradually varied from “dark” to “bright” in numerical order of the gate lines 25, so that the luminance in a vertical direction with respect to the liquid crystal panel seems uniformed.

Next, the following description explains an example of (i) a line whose γ correction value should be changed and (ii) the correction value thereof for obtaining “most appropriate visual angle”.

The nonvolatile memory (display memories 515 and 516) stores different plural sets of the characteristic data, and each characteristic data is constituted of many sets of unit data to which addresses have been given in a numerical order of the gate lines 25 (or in an order based on key numbers), and each unit data corresponds to the adjustment data D2 or D3 described in the embodiments of the invention. According to the nonvolatile memory, single characteristic data is selected on the basis of a control signal for example, and single unit data (adjustment data) contained in the selected characteristic data is read out on the basis of the signal. Each of the signs D2 and D3 represents basic adjustment data that has been read out.

The γ correction adjustment circuit 531 included in the reference voltage generating circuit 521 adjusts the reference voltage on the basis of the adjustment data D2 read out from the non-volatile memory. Further, the Vcom adjustment section 553 included in the Vcom adjustment circuit 517 adjusts the Vcom reference voltage on the basis of the adjustment data D3 read out from the nonvolatile memory.

Thus, the nonvolatile memory corresponds to retaining means for retaining the basic adjustment data for each number or each key number of the gate line 25, and the adjustment data is used to perform adjustment for increasing or decreasing the γ value of the reference voltage and to adjust a reference voltage value of the counter electrode (common electrode). In such arrangement, each characteristic data stored in the nonvolatile memory is set on the basis of a relationship between the liquid crystal panel and an eye shot (visual line).

For example, in the case of the liquid crystal panel which seems to vary from “dark” to “bright” while the observer's view point is moving from the upper direction to the lower direction when the observer faces the liquid crystal panel, there is set the characteristic data in which the adjustment data are disposed so that the luminance is gradually varied in a numerical order of the date lines 25. When the characteristic data is selected, the γ value of the reference voltage and the reference voltage value of the counter electrode (common electrode) are corrected in accordance with the adjustment data read out from the nonvolatile memory in a numerical order of the gate lines 25, so that the luminance in a vertical direction with respect to the liquid crystal panel seems uniformed only in a case where the observer faces the liquid crystal panel.

Further, in the case of the liquid crystal panel which seems to vary from “bright” to “dark” while the observer's view point is moving from the lower direction to the upper direction, there is set the characteristic data in which the adjustment data are disposed so that the luminance is gradually varied from “dark” to “bright” in a numerical order of the gate lines 25. When the characteristic data is selected, the γ value of the reference voltage and the reference voltage value of the counter electrode (common electrode) are corrected in accordance with the adjustment data read out from the nonvolatile memory in a numerical order of the gate lines 25, so that the luminance in a vertical direction with respect to the liquid crystal panel seems uniformed only in a case where the observer faces the liquid crystal panel.

Further, in the embodiments of the present invention, the gate lines 25 positioned on the upper side and the gate lines 25 positioned on the lower side are different from each other in terms of the gamma characteristic in one frame (FIG. 24), so that only a predetermined line can have a gamma characteristic different from that in other lines. Thus, it is possible to vary the display characteristic so that the visual angle corresponds to the most appropriate angular position in viewing.

Next, a reason for which the γ correction is varied for each of one to m gate lines 25 is described as follows.

As described above, the visual angle with respect to the liquid crystal varies depending on the intensity of the driving voltage applied to the liquid crystal. Thus, when the distribution of the gradation voltage is adjusted, in a single display device, as shown in FIG. 33(a) or FIG. 33(b), it is possible to set the display condition under which there are visual angles different from each other.

Further, the γ characteristics are respectively adjusted in the gate lines 25 positioned on the upper side and the gate lines 25 positioned on the lower side, so that human eyes which percept whole the image have perceptive characteristic with respect to light (unevenness of the panel characteristics seems uniformed, and an apparent image does not vary when viewed from both the upper direction and the lower direction), so that the observer feels wideness with the upper and lower visual angles added as shown in FIG. 34.

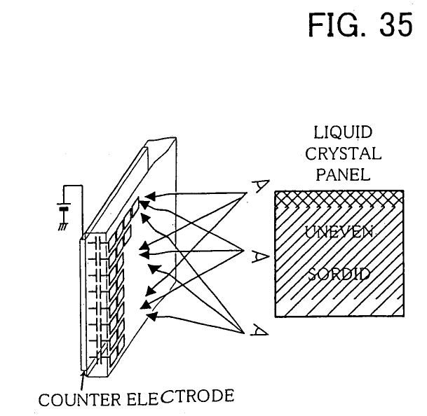

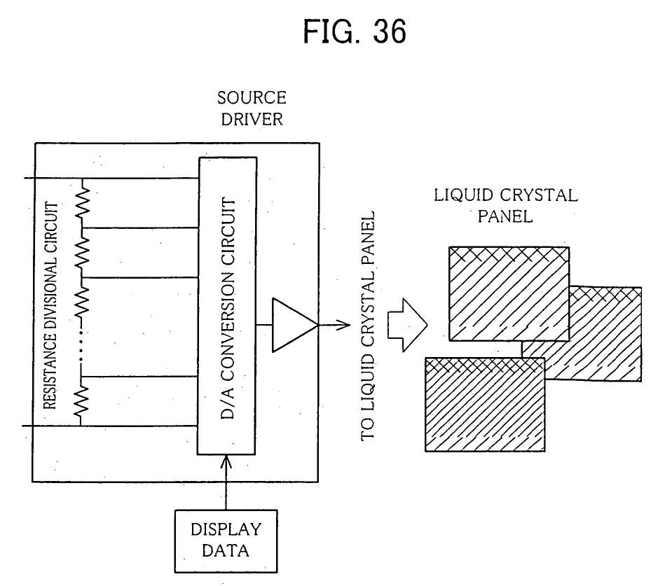

Further, as shown in FIG. 35 and FIG. 36 each of which shows a conventional technique, the observer percepts more obvious difference between the upper side and the lower side of the image in terms of the visual angle characteristic when the image is displayed in a larger screen, so that the difference is unable to disregard.

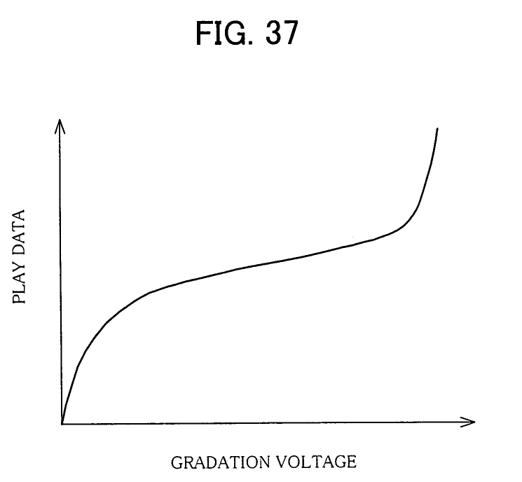

In this case, according to the conventional technique, as shown in FIG. 36, a voltage applied to the liquid crystal panel is generated on the basis of a voltage (fixed voltage) divided by a resistance dividing circuit of the source driver, so that the γ characteristic is fixed to a characteristic of FIG. 37 for example. Thus, in order to vary the γ characteristic, it is necessary to newly remake the source driver.

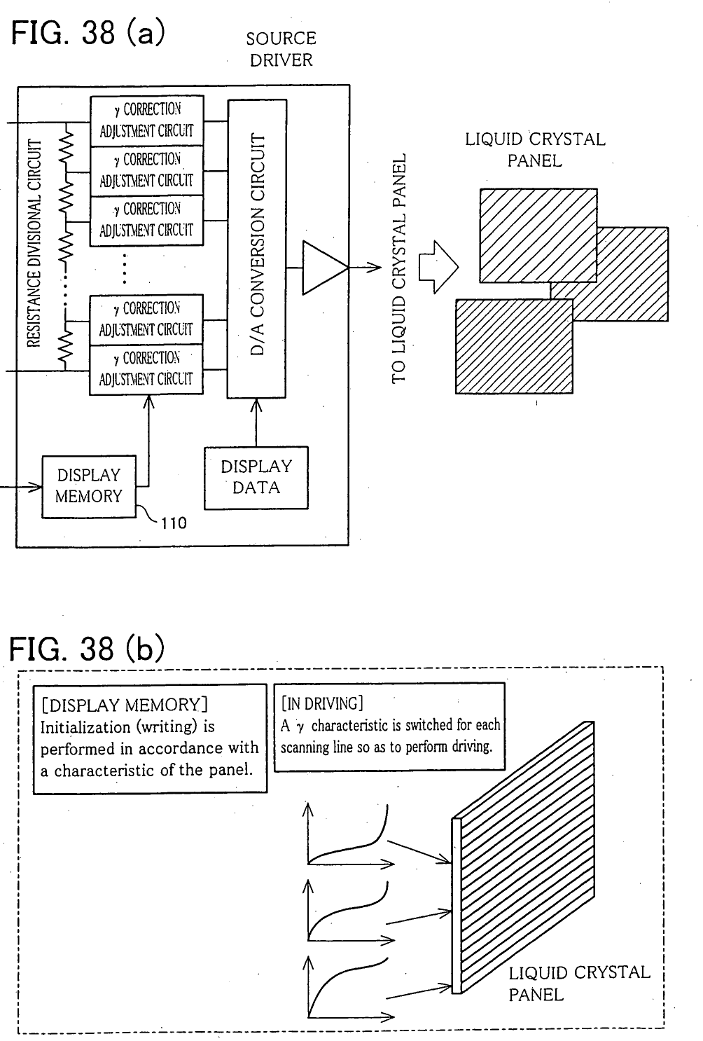

In contrast, according to the arrangement of the embodiments of the present invention, as shown in FIG. 38(a) and FIG. 38(b), a voltage applied to the liquid crystal panel is generated on the basis of a voltage (voltage which can be adjusted as required) that the source driver has adjusted by means of the γ correction adjustment circuit in advance. Thus, it is possible to adjust the γ characteristic as required.

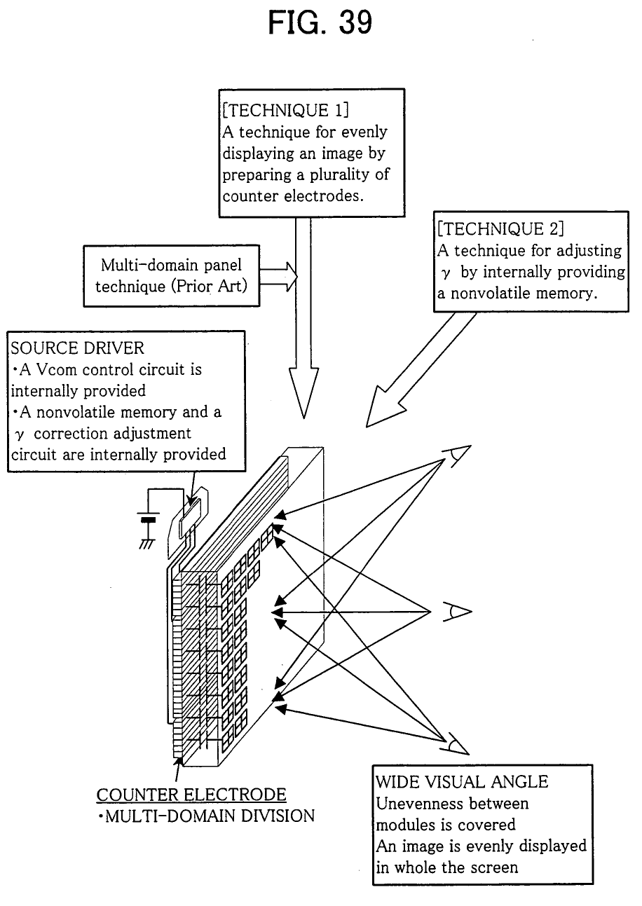

As described above, the liquid crystal display device of the present embodiment has (i) a uniform display technique realized by dividing the counter electrodes and (ii) a γ adjustment technique realized by internally providing the nonvolatile memory as shown in FIG. 39.

Next, an example of how the display memories 515 and 516 are arranged is described as follows.

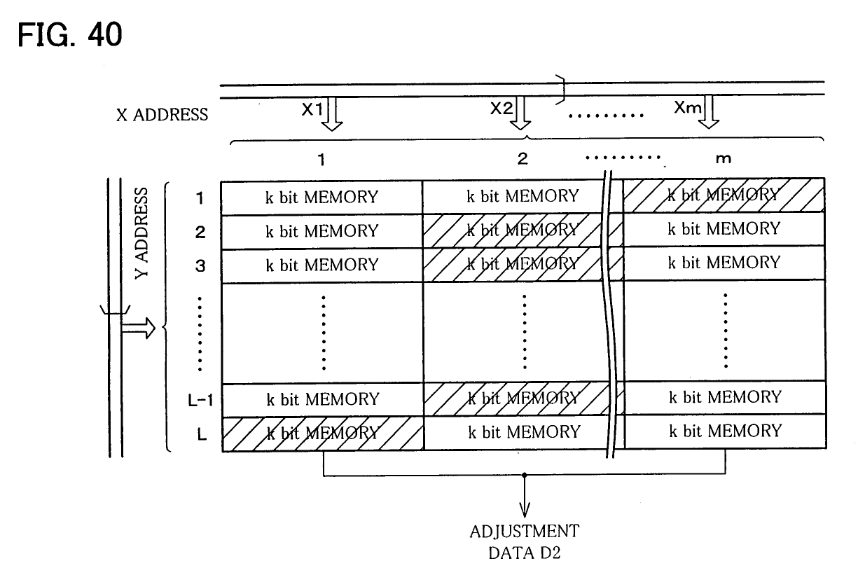

The display memory is not particularly limited, but may be arranged so that: as shown in FIG. 40, there is provided a memory array constituted of memory cells, disposed in a vertical direction (Y direction) as L rows and disposed in a horizontal direction (X direction) as m columns, each of which is K bit. Further, it may be so arranged that the display memory includes: a Y address generating circuit, provided in a periphery of the display memory, which generates a Y address (not shown); a Y decoder which outputs a single-row decode signal in accordance with address data outputted from the Y address generating circuit; and an X decoder which outputs a decode signal of a single row×K bit in accordance with a control signal (n bit).

The display memory performs initialization (writing) in accordance with a characteristic of the liquid crystal panel in advance. For example, the Y address generating circuit counts up the written address data sequentially in synchronism with a horizontal synchronization signal H, and the Y decoder selects a single row from L rows in accordance with the address data outputted from the Y address generating circuit.

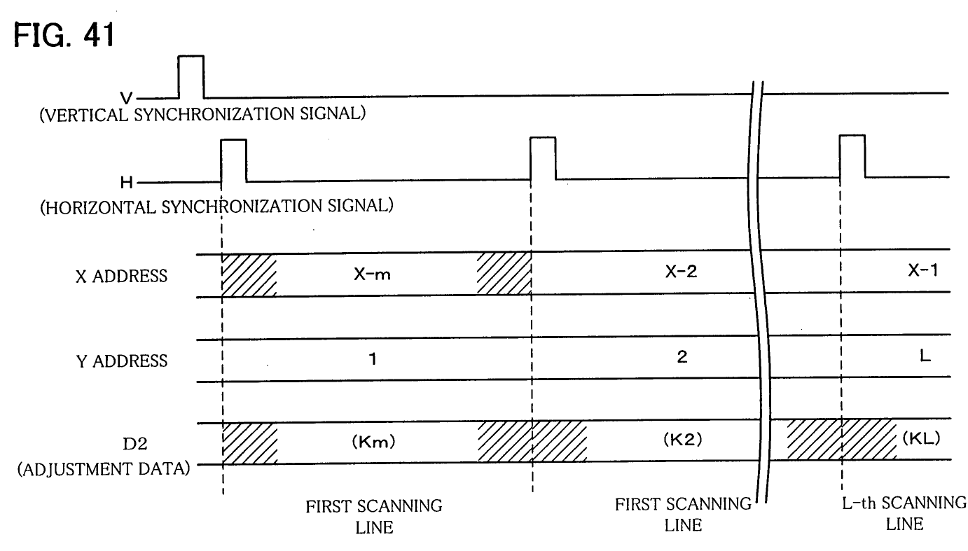

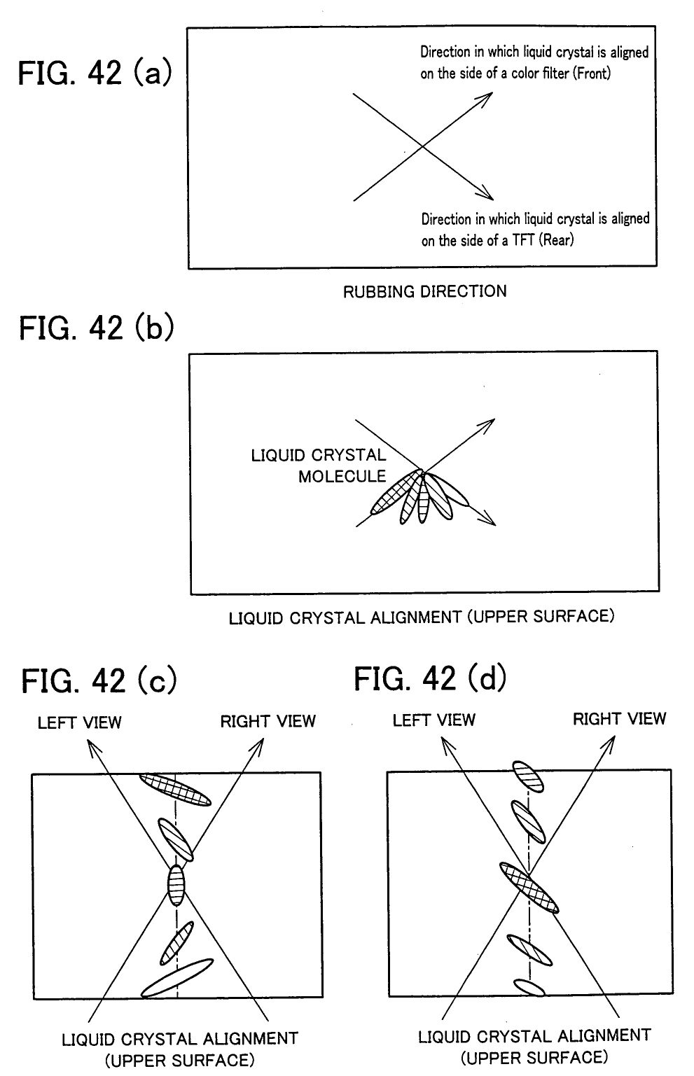

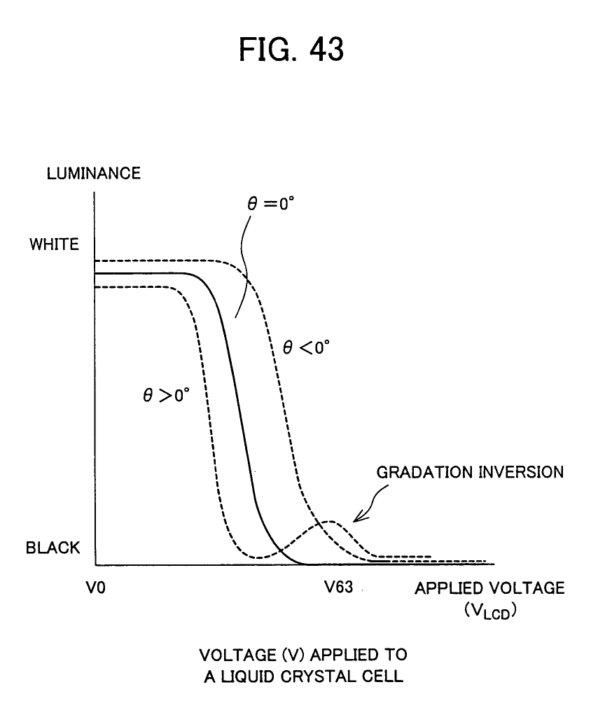

While, the X decoder selects a decode signal of a single row×K bit out of m rows in synchronism with the horizontal synchronization signal H in accordance with the control signal (n bit). The selected k-bit data is outputted as the adjustment data D2, and is inputted to the reference voltage generating circuit 512. FIG. 41 shows a simple timing chart concerning the foregoing operations.

Note that, each of FIG. 40 and FIG. 41 shows an example where the adjustment data D2 is outputted to each gate line 25, but the adjustment data D2 may be varied for every plural gate lines 25. In this case, the display memory is set so that: when predetermined plural addresses are inputted by the address counter, the addresses in the memory are counted up. Thus, this setting can be made by a known technique.

As described above, the liquid crystal display device of the present invention includes: a pair of substrates, having no alignment structure, which are provided in an optically and structurally equal direction; and a liquid crystal layer sandwiched by the pair of common electrode substrates, wherein pixels are disposed in a row direction and in a column direction, and liquid crystal molecules of the liquid crystal layer are aligned in substantially all directions into a plane of each substrate with equal probability in broad perspective, and a multi-domain liquid crystal element having liquid crystal molecules each of which has a substantially fixed twist angle in a direction perpendicular to the substrates is used, and the liquid crystal display device includes control means for controlling a voltage of each common electrode substrate in accordance with the multi-domain liquid crystal and a luminance characteristic with respect to an angular position in viewing.

The method of the present invention is to drive the liquid crystal display device which includes: a pair of substrates, having no alignment structure, which are provided in an optically and structurally equal direction; and a liquid crystal layer sandwiched by the pair of common electrode substrates, wherein pixels are disposed in a row direction and in a column direction, and liquid crystal molecules of the liquid crystal layer are aligned in substantially all directions into a plane of each substrate with equal probability in broad perspective, and a multi-domain liquid crystal element having liquid crystal molecules each of which has a substantially fixed twist angle in a direction perpendicular to substrates is used, and the method is characterized in that a voltage of each common electrode substrate is controlled in accordance with the multi-domain liquid crystal and a luminance characteristic with respect to an angular position in viewing.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal display device, comprising:
a plurality of scanning lines;
a plurality of signal lines provided so as to cross the scanning signals;
a liquid crystal layer having liquid crystal molecules, aligned in random directions throughout a liquid crystal panel, each of which has a substantially fixed twist angle in a direction perpendicular to substrates sandwiching the liquid crystal layer;
pixel capacitors, respectively formed on pixels corresponding to intersections of the scanning lines and the signal lines, which include pixel electrodes and common electrodes, and correspond to the liquid crystal layer; and
a common electrode voltage supplying circuit for supplying common electrode voltages to the common electrodes, said common electrode Voltage supplying circuit being capable of adjusting the common electrode voltages.

2. The liquid crystal display device as set forth in claim 1, wherein:
the common electrodes of the pixels are divided into a plurality of groups, and
the common electrode voltage supplying circuit is capable of respectively adjusting the common electrode voltages so that the common electrode voltages are adjusted independently every groups.

3. The liquid crystal display device as set forth in claim 1, wherein:
at least first pixel capacitors and second pixel capacitors are provided on each of the pixels as the pixel capacitors, and
the common electrode voltage supplying circuit is capable of respectively independently adjusting a common electrode voltage supplied to common electrodes corresponding to the first pixel capacitors and common electrode voltages supplied to common electrodes corresponding to the second pixel capacitors.

4. The liquid crystal display device as set forth in claim 3, wherein:
the common electrodes corresponding to the second pixel capacitors are divided into a plurality of groups, and
the common electrode voltage supplying circuit supplies the common electrode voltage of an equal value to each other to the common electrodes corresponding to the first pixel capacitors, and is capable of respectively adjusting the common electrode voltages supplied to the common electrodes corresponding to the second pixel capacitors independently every groups.

5. The liquid crystal display device as set forth in claim 4, wherein:
the common electrodes corresponding to the first pixel capacitors are divided into a plurality of groups, and the common electrode corresponding to the second pixel capacitors are divided into a plurality of groups, and
the common electrode voltage supplying circuit is capable of respectively adjusting the common electrode voltage supplied to the common electrodes corresponding to the first pixel capacitor independently every groups and is capable of respectively adjusting the common electrode voltages supplied to the common electrodes corresponding to the second pixel capacitors independently ever groups.

6. The liquid crystal display device as set forth in claim 2, wherein the common electrodes are grouped for n lines of the scanning lines (n includes one), where n is a positive integer.

7. The liquid crystal display device as set forth in claim 4, wherein the common electrodes are grouped for n lines of the scanning lines (n includes one), where n is a positive integer.

8. The liquid crystal display device as set forth in claim 6, wherein:
the common electrode voltage supplying circuit supplies a common electrode voltage which functions as a reference common electrode voltage to a group corresponding to a scanning line positioned on the one side in a direction in which the scanning signals are disposed, and
the common electrode voltage supplying circuit supplies a common electrode voltage which has a value different from a value of the reference common electrode voltage to a group corresponding to a scanning line positioned on the other side in the direction in which the scanning signals are disposed.

9. The liquid crystal display device as set forth in claim 7, wherein:
the common electrode voltage supplying circuit supplies a common electrode voltage which functions as a reference common electrode voltage to a group corresponding to a scanning line positioned on the one side in a direction in which the scanning signals are disposed, and
the common electrode voltage supplying circuit supplies a common electrode voltage which has a value different from a value of the reference common electrode voltage to a group corresponding to a scanning line positioned on the other side in the direction in which the scanning signals are disposed.

10. The liquid crystal display device as set forth in claim 6, wherein:
the common electrode voltage supplying circuit supplies a common electrode voltage which functions as a reference common electrode voltage to a first group corresponding to a scanning line centered in a direction in which the scanning lines are disposed, and
the common electrode voltage supplying circuit supplies a common electrode voltages which is higher than the reference common electrode voltage to a second group corresponding to a scanning line positioned on the one side in the direction in which the scanning lines are disposed, and
the common electrode voltage supplying circuit supplies a common electrode voltage which is lower than the reference common electrode voltage to a third group corresponding to a scanning line positioned on the other side in the direction in which the scanning lines are disposed.

11. The liquid crystal display device as set forth in claim 7, wherein:
the common electrode voltage supplying circuit supplies a common electrode voltage which functions as a reference common electrode voltage to a first group corresponding to a scanning line centered in a direction in which the scanning lines are disposed, and
the common electrode voltage supplying circuit supplies a common electrode voltages which is higher than the reference common electrode voltage to a second group corresponding to a scanning line positioned on the one side in the direction in which the scanning lines are disposed, and
the common electrode voltage supplying circuit supplies a common electrode voltage which is lower than the reference common electrode voltage to a third group corresponding to a scanning line positioned on the other side in the direction in which the scanning lines are disposed.

12. The liquid crystal display device as set forth in claim 1, comprising a signal line driving circuit for supplying a display signal voltage to each of the signal lines, wherein
the common electrode voltage supplying circuit is provided in the signal line driving circuit.

13. The liquid crystal display device as set forth in claim 6, wherein the common electrode voltage supplying circuit adjusts the common electrode voltages supplied to the groups so that luminance of the pixels gradually varies so as to be monotonously darker or so as to be monotonously brighter from one end side to a center of the scanning lines in a direction in which the scanning lines are disposed.

14. The liquid crystal display device as set forth in claim 7, wherein the common electrode voltage supplying circuit adjusts the common electrode voltages supplied to the groups so that luminance of the pixels gradually varies so as to be monotonously darker or so as to be monotonously brighter from one end side to a center of the scanning lines in a direction in which the scanning lines are disposed.

15. The liquid crystal display device as set forth in claim 1, wherein the common electrode voltage supplying circuit includes an input operation circuit which allows adjustment amounts of the common electrode voltages to be inputted.

16. The liquid crystal display device as set forth in claim 2, wherein the common electrode voltage supplying circuit adjusts the common electrode voltages so that luminance and color variation of the pixels are corrected so that a visual angle with respect to a liquid crystal panel, viewed from an arbitrary position, is wider than a visual angle in a case where the common electrode voltages of all the groups are equal to each other.

17. The liquid crystal display device as set forth in claim 16, wherein the common electrode voltage supplying circuit adjusts the common electrode voltages so that luminance and color variation of the pixels are corrected so that a visual angle with respect to a liquid crystal panel, seen from an arbitrary position in an up-and-down direction, is wider than a visual angle in a case where the common electrode voltages of all the groups are equal to each other.

18. The liquid crystal display device as set forth in claim 4, wherein the common electrode voltage supplying circuit adjusts the common electrode voltages so that luminance and color variation of the pixels are corrected so that a visual angle with respect to a liquid crystal panel, seen from an arbitrary position, is wider than a visual angle in a case where the common electrode voltages of all the groups are equal to each other.

19. The liquid crystal display device as set forth in claim 18, wherein the common electrode voltage supplying circuit adjusts the common electrode voltages so that luminance and color variation of the pixels are corrected so that a visual angle with respect to a liquid crystal panel, seen from an arbitrary position in an up-and-down direction, is wider than a visual angle in a case where the common electrode voltages of all the groups are equal to each other.

20. The liquid crystal display device as set forth in claim 1, wherein
the common voltage supplying circuit includes:
an input terminal for receiving a voltage which functions as a standard voltage of the common electrode voltages;
a resistance element whose one end is connected to the input terminal;
a constant current source for causing a constant current to flow to the resistance element;
an output terminal, connected to other end of the resistance element, which outputs an output voltage; and
a data latch circuit for outputting adjustment data, in accordance with which (i) a current value of the constant current caused to flow by the constant current source and (ii) a direction in which the constant current caused to flow are switched, to the constant current source.

21. The liquid crystal display device as set forth in claim 1, comprising:
a scanning line driving circuit for driving the scanning lines; and
a reference voltage generating circuit for generating reference voltages, having plural levels different from each other, which are supplied to the scanning line driving circuit so as to make gradation display in accordance with a display signal, said reference voltage generating circuit being capable of adjusting the reference voltages.

22. The liquid crystal display device as set forth in claim 21, wherein the reference voltage generating circuit adjusts the reference voltages so that a predetermined gamma characteristic is obtained in an arbitrary line of lines each of which is constituted of the pixels provided in a direction in which the scanning lines are disposed.

23. The liquid crystal display device as set forth in claim 21, comprising a correction information storage circuit for storing adjustment amounts of the reference voltages, wherein
the reference voltage generating circuit adjusts the reference voltages in accordance with the adjustment amounts stored in the correction information storage circuit.

24. The liquid crystal display device as set forth in claim 22, wherein the reference voltage generating circuit adjusts the reference voltages so that a gamma characteristic is obtained in a line, constituted of the pixels, which is positioned on the one side in a direction in which the scanning lines are disposed and another gamma characteristic is obtained in a line, constituted of the pixels, which is positioned on the other side in the direction in which the scanning lines are disposed, said gamma characteristics being different from each other.

25. The liquid crystal display device as set forth in claim 22, wherein the reference voltage generating circuit adjusts the reference voltages so as to obtain gamma characteristics different from each other in a first line constituted of the pixels provided on the one side in a direction in which the scanning lines are disposed, a second line constituted of the pixels provided on the other side in the direction in which the scanning lines are disposed, and a third line constituted of the pixels provided between the first line and the second line so that the gamma characteristic obtained in the third line is intermediate between the gamma characteristic obtained in the first line and the gamma characteristic obtained in the second line.

26. The liquid crystal display device as set forth in claim 21, wherein:
the reference voltage generating circuit adjusts the reference voltages so as to obtain a gamma characteristic which causes luminance to decrease in a numerical order of the scanning lines in a case of using a liquid crystal panel whose luminance increases while a view point is moving from an upper direction to a lower direction with respect to the liquid crystal panel when an observer faces the liquid crystal panel, and
the reference voltage generating circuit adjusts the reference voltages so as to obtain a gamma characteristic which causes the luminance to increase in a numerical order of the scanning lines in a case of a liquid crystal panel whose luminance decreases while the view point is moving from the upper direction to the lower direction with respect to the liquid crystal panel when the observer faces the liquid crystal panel.

27. The liquid crystal display device as set forth in claim 26, wherein:
the common electrode voltage supplying circuit adjusts the common electrode voltages so that the luminance decreases in the numerical order of the scanning lines in the case of using the liquid crystal panel whose luminance increases while the view point is moving from the upper direction to the lower direction with respect to the liquid crystal panel when the observer faces the liquid crystal panel, and
the common electrode voltage supplying circuit adjusts the common electrode voltages so that the luminance increases in the numerical order of the scanning lines in the case of using the liquid crystal panel whose luminance decreases while the view point is moving from the upper direction to the lower direction with respect to the liquid crystal panel when the observer faces the liquid crystal panel.

28. A method for driving a liquid crystal display device which includes: a plurality of scanning lines; a plurality of signal lines provided so as to cross the scanning signals; pixel capacitors, having pixel electrodes and common electrodes, and corresponding to a liquid crystal layer, which are respectively formed on pixels corresponding to intersections of the scanning lines and the signal lines, wherein the liquid crystal layer has liquid crystal molecules, aligned in random directions throughout a liquid crystal panel, each of which has a substantially fixed twist angle in a direction perpendicular to substrates for sandwiching the liquid crystal layer,
said method comprising the step of supplying common electrode voltages and adjusting the common electrode voltages.

29. The method as set forth in claim 28, wherein the common electrodes of the pixels are divided into a plurality of groups, and the common electrode voltages are respectively adjusted so as to be adjusted independently every groups.

30. The method as set forth in claim 28, comprising the step of generating reference voltages, having plural levels, which cause gradation display to be made in accordance with a display signal, and adjusting the reference voltages.

31. The method as set forth in claim 30, wherein the reference voltages are adjusted so that a predetermined gamma characteristic is obtained in an arbitrary line of lines each of which is constituted of the pixels provided in a direction in which the scanning lines are disposed.

32. The method as set forth in claim 29, wherein the common electrode voltages are adjusted so that luminance and color variation of the pixels are corrected so that a visual angle with respect to a liquid crystal panel, viewed from an arbitrary position, is wider than a visual angle in a case where the common electrode voltages of all the groups are equal to each other.

33. The method as set forth in claim 32, wherein the common electrode voltages are adjusted so that luminance and color variation of the pixels are corrected so that a visual angle with respect to a liquid crystal panel, viewed from an arbitrary position in an up-and-down direction, is wider than a visual angle in a case where the common electrode voltages of all the groups are equal to each other.

34. The method as set forth in claim 33, wherein the common electrodes in each of the pixels are sequentially grouped for n lines of the scanning lines (n includes one), where n is a positive integer.
